(19) United States
(12) Patent Application Publication
(10) Pub. No.: US 2024/0203153 A1
(43) Pub. Date: Jun. 20, 2024

(54) METHOD AND SYSTEM FOR TESTING USING LOW RANGE ELECTROMAGNETIC WAVES

(71) Applicants: George SHAKER, Waterloo (CA); Ala Eldin OMER, Waterloo (CA)

(72) Inventors: George SHAKER, Waterloo (CA); Ala Eldin OMER, Waterloo (CA)

(21) Appl. No.: 18/236,526

(22) Filed: Aug. 22, 2023

Related U.S. Application Data
(63) Continuation-in-part of application No. 17/026,452, filed on Sep. 21, 2020.
Application No. 17/026,452 is a division of application No. 15/819,833, filed on Nov. 21, 2017, now Pat. No. 11,380,118.
(63) Continuation-in-part of application No. 17/139,184, filed on Dec. 31, 2020.
(60) Provisional application No. 62/497,430, filed on Nov. 21, 2016.
(60) Provisional application No. 63/399,760, filed on Aug. 22, 2022.

(51) Int. Cl. G06V 40/13; G06V 10/143; G06V 40/10; G06V 40/12; G06V 40/14

(52) U.S. Cl. CPC G06V 40/1312; G06V 10/143; G06V 40/10; G06V 40/12; G06V 40/1341; G06V 40/14

(57) ABSTRACT

The disclosure is directed at a method and system for determining characteristics of a packaged liquid using electromagnetic waves. The system includes a sensing system that includes at least one transmitter and at least one receiver that transmits electromagnetic waves towards the packaged liquid and then receives reflected waves from the packaged liquid. The reflected waves are then processed to determine characteristics of the packaged liquid.

### CROSS-REFERENCE TO OTHER APPLICATIONS

This application is a continuation-in-part (CIP) of U.S. patent application Ser. No. 17/139,184 filed Dec. 31, 2020 which is a CIP of U.S. patent application Ser. No. 15/819,833 filed Nov. 21, 2017 which claims priority from U.S. Provisional Application No. 62/497,430 filed Nov. 21, 2016; and a CIP of U.S. patent application Ser. No. 17/026,452 filed Sep. 21, 2020 which is a divisional of U.S. patent application Ser. No. 15/819,833 filed Nov. 21, 2017 which claims priority from U.S. Provisional Application No. 62/497,430 filed Nov. 21, 2016 and claims priority from U.S. Provisional Patent Application No. 63/399,760 filed Aug. 22, 2022, all of which are hereby incorporated herein by reference.

### FIELD

The disclosure is generally directed at sensor systems, and more specifically, at a method and system for testing objects using low range electromagnetic (EM) waves.

### BACKGROUND

As the food industry continues to grow, food safety and inspection is becoming more and more important. Food composition is also important such as with products, such as milk, where certain milk products require an expected butterfat concentration.

During the manufacturing process, composition issues can arise as a result of various factors such as physical/liquid contaminants, piping system issues, products changeover, accidental flaws, etc., that can result in poor quality products with potentially massive consequences on the manufacturing efficiencies and the company's brand. Unfortunately, traditional quality control tools do not provide timely information that could reduce or prevent any subsequent losses.

Therefore, there is provided a novel method and system for testing liquids within a container using low range electromagnetic waves.

### SUMMARY

In one aspect of the disclosure, there is provided a method for testing a packaged item including transmitting a set of low range electromagnetic waves at the packaged item; receiving a set of scattered low range electromagnetic waves, wherein the set of scattered low range electromagnetic waves are fully correlated to the packaged item; determining a relative complex permittivity of the packaged item; and processing the relative complex permittivity to determine a characteristic of the packaged item.

In another aspect, the packaged item is a packaged fluid. In yet a further aspect, the packaged fluid is milk and the characteristic is one of a butterfat percentage of the milk, volume of content or amount of contaminants. In yet another aspect, transmitting a set of low range electromagnetic waves includes transmitting electromagnetic waves in a frequency range of about 1 GHz to about 300 GHz. In yet a further aspect, the method includes, after receiving a set of scattered low range electromagnetic waves, determining a dielectric constant and a dielectric loss factor for the packaged fluid. In another aspect, determining a relative complex permittivity of the packaged fluid includes processing the dielectric constant and the dielectric loss factor. In another aspect, processing the dielectric constant and the dielectric loss factor comprises includes processing a magnitude and phase of complex scattering data using a machine learning algorithm (MLA). In another aspect, the MLA includes a time series random forest (RF), support vector machines (SVM), a principal component analysis (PCA), a recurrent neural network (RNN), a gated recurrent unit (GRU), long short-term memory models (LSTM), or a complex neural network.

In a further aspect, the set of scattered low range electromagnetic waves are a set of reflected low range electromagnetic waves. In another aspect, the method includes, after receiving a set of scattered low range electromagnetic waves, processing the set of scattered low range electromagnetic waves via a continuous wavelet transform (CWT), an empirical mode decomposition (EMD), a discrete wavelet transform (DWT), a power spectral density (PSD), a fast Fourier transform (FFT), or short-time Fourier Transform (STFT).

In another aspect of the disclosure, there is provided a glucose monitoring device including at least one transmitter for transmitting electromagnetic waves at a target; at least one receiver for receiving reflected electromagnetic waves from the target; and a glucose monitoring unit for processing the reflected electromagnetic waves.

In another aspect, the at least one transmitter and the at least one receiver are implemented within a complementary split-ring resonators (CSRR) sensor. In yet another aspect, the CSRR sensor is a single pole CSRR sensor, a triple pole CSRR sensor or a honey-cell CSRR sensor. In yet a further aspect, the at least one transmitter and the at least one receiver are implemented within a whispering-gallery mode (WGM) sensor. In yet another aspect, the at least one transmitter and the at least one receiver are connected to the glucose monitoring unit via individual co-axial cables.

### BRIEF DESCRIPTION OF THE DRAWINGS

Various aspects and features of the present disclosure will become apparent to those ordinarily skilled in the art upon review of the following description of specific embodiments in conjunction with the accompanying figures.

Embodiments of the present disclosure will now be described, by way of example only, with reference to the attached Figures.

FIG. 1 is a schematic diagram of an apparatus for use in examining a liquid using microwaves or millimeter waves;

FIG. 2 is a flowchart showing a method of examining a liquid using microwaves or millimeter waves;

FIG. 3 is a flowchart showing a method of examining a liquid using microwaves or millimeter waves;

FIG. 4 is a photograph of another embodiment of a system for examining a liquid using microwaves or millimeter waves;

FIGS. 5a and 5b are graphs showing test results;

FIG. 6 is a chart showing tested milk products;

FIG. 7 is a schematic diagram of another embodiment of an apparatus for use in examining a liquid using microwaves or millimeter waves;

FIG. 8 is a schematic diagram of a service-oriented architecture (SOA);

FIG. 9a is a schematic diagram of a ferrite ring resonator (FRR);

FIG. 9b is a drawing of electric field distribution;

FIG. 10a is a graph showing the coupling level variations with respect to the loss tangent of FRR with respect to the Transmission coefficient;

FIG. 10b is a graph showing the coupling level variations with respect to the loss tangent of FRR with respect to the Transmission phase (EM Simulation);

FIGS. 11a and 11b are diagrams showing FRR properties;

FIGS. 12a and 12b are graphs showing EM simulated transmission responses for the unloaded FRR at different gap spaces with respect to (a) Transmission coefficient (b) Transmission phase;

FIGS. 13a and 13b are graphs showing unloaded WGM₆₀₀ response (magnitude and phase) of the sensor at both S₂₁ and S₁₂;

FIG. 14 is a flowchart showing a further embodiment of a method of examining a liquid using microwaves or millimeter waves;

FIGS. 15a and 15b are graphs showing WGM₆₀₀ responses to the six oil samples in terms of |S₁₂| and |S₂₁|;

FIGS. 16a and 16b are graphs showing WGM₆₀₀ responses to the six oil samples

in terms of ∠S₁₂, and ∠S₂₁;

FIGS. 17a to 17c are charts showing testing results;

FIGS. 18a and 18b are photographs showing an experimental setup for testing a) skim milk and b) 2% milk;

FIG. 18c is a schematic diagram of spacing between milk cartons for the experimental setup;

FIG. 19a is a graph showing the radar amplitude measurements in four receiving channels for different milk products (skim and 2%);

FIGS. 20a and 20b are photographs showing an experimental setup for testing a) 1% milk and b) 3.25% milk;

FIG. 21a is a graph showing the radar amplitude measurements in four receiving channels for different milk products (skim, 1%, 2%, and 3.25%);

FIGS. 22a to 22c are charts showing results from other beverage testing;

FIG. 23 is a schematic diagram of another system for sensing;

FIG. 24 is a schematic diagram showing further detail of the system of FIG. 23;

FIG. 25 is a flowchart showing another method for sensing;

FIG. 26 are diagrams showing signal processing results;

FIG. 27 is a flowchart of yet another method for sensing;

FIGS. 28a and 28b are schematic diagrams showing a portable glucose monitoring device;

FIG. 29a is a schematic diagram of a dipole antenna used as a reader;

FIG. 29b is a schematic diagram of an integrated sensor structure with a single-pole CSRR tag;

FIG. 29c is a schematic diagram of an integrated sensor structure with a triple-pole CSRR tag;

FIG. 29d is a graph showing a comparison of simulated reflection coefficient responses;

FIG. 30a is a simulation model of the glucose samples in the sensing region of the TP-CSRR tag;

FIG. 30b is an image of electric field distribution;

FIGS. 31a to 31c are graphs showing simulated reflection responses at d=4 mm;

FIGS. 32a to 32c are graphs showing simulated reflection responses at d=5 mm;

FIGS. 33a and 33b are graphs showing resonant amplitudes;

FIG. 33c is an image of electric field distribution for a SP-CSRR tag;

FIG. 33d is an image of electric field distribution for a TP=CSRR tag;

FIG. 34 is a schematic front view of an integrated CSRR sensor;

FIGS. 35a to 35c are graphs showing reflection responses;

FIG. 36 is a schematic diagram of another embodiment of a portable glucose monitoring device

FIG. 37 is a photograph of a radar board for use with the glucose monitoring device of FIG. 36;

FIGS. 38a to 38c are graphs showing glucose testing results;

FIGS. 39a to 39c are graphs comparing blood glucose readings from a CSRR device and a glucometer;

FIG. 40 is a schematic diagram of another portable glucose monitoring device;

FIG. 41a is shows a SP-CSRR sensor and S₂₁ measurements;

FIG. 41b is a set of photographs showing use of Honey-Cell CSRR sensors in testing milk samples; and

FIG. 41c is a set of graphs showing S₂₁ measurements (magnitude and phase) of different milk products tested on honey-cell CSRR sensors.

### DETAILED DESCRIPTION

The disclosure is directed at a method and system for testing an item within a container to determine at least one characteristic of the item or container using low frequency electromagnetic waves, or microwaves, or high frequency electromagnetic waves, or millimeter waves. For simplicity, the combination of the item and container will be referred to as a product in the following description. In one embodiment, the electromagnetic waves are in a frequency range or about 1 GHz to about 300 GHz.

In some embodiments, the item may be a food item such as, but not limited to, dry goods, milk, oil, carbonated drinks, juices, chips and the like. In other embodiments, the container may be a carton, a bottle, plastic packaging, foil packaging and the like.

The disclosure transmits electromagnetic waves at the product and then receives reflected electromagnetic waves which are then processed by the disclosure to determine at least one characteristics of the item, the container or the product. For example, the one characteristic of the item may be the percentage butterfat of milk within a milk carton to ensure that the milk within a specific milk carton or container contains a correct amount of butterfat. In another example, the one characteristic of the item may be a purity of an olive oil within an olive oil container or bottle.

In one embodiment, the disclosure may be seen as a compact wireless sensing system for rapid quality control monitoring of packaged fluids or packaged food items in production lines. In one embodiment, the disclosure is a device that uses advanced radar technology to test containers, such as, but not limited to, bottles, bags or cartons, non-invasively that have food items within in a short time. When installed on a conveyor belt, the disclosure scans the product in the short period of time (milliseconds) by sending electromagnetic waves that interact with the container and food item and then reflect back to a receiver. The measured raw data may then be processed using advanced signal processing and artificial intelligence (AI) algorithms to check the quality status (seen as a characteristic) of the food items against specific benchmarks and provide a digital assessment. In other embodiments, characteristics of the container may also be determined.

In one embodiment of determining the at least one characteristic, the raw data may be streamed to the cloud for data processing. By integrating the disclosure with applications stored with cloud storage, may provide a rapid automated quality testing with smart alerts for immediate actionable recommendations on product manufacturing.

Embodiments of the method and system disclosed herein are intended to use a wireless transceiver (for example mm-wave; generally, between 30 GHz to 300 GHz). The transceiver will have a transmitter(s) sending a sequence of signals. The signals will be reflected and scattered from a product. In some embodiments, the signals may be reflected and scattered from a body part if the disclosure is being used to test for or monitor a glucose level within an individual. The transceiver will have receiver(s) that receive signals reflected and scattered from the object. The system will apply different signal processing algorithms to the received signals in order to identify the object and/or differentiate between various objects. It will be understood that depending on the radar bandwidth and machine learning involved, objects may be in a range of distance from the system. In some cases, the objects may be between a few millimeters to a hundred meters from the system.

Embodiments of the system and method detect and collect the signals. The collected signals are then processed. The signals depend on the specific geometries of the fingerprint/palm, plus the skin electric/magnetic properties and all of the underlying veins/bones. Based on the levels of diffraction, refraction, and reflection occurred, a signal processing algorithm is used to classify the data to determine whether the hand detected belongs to a specific user or not.

In a method for sensing, the data may first be generated by the radar/radio sensor. The data is sorted, and certain set of algorithms are applied, for example AI, Machine learning, or the like. Then, a decision tree is generated and the individual or object is identified.

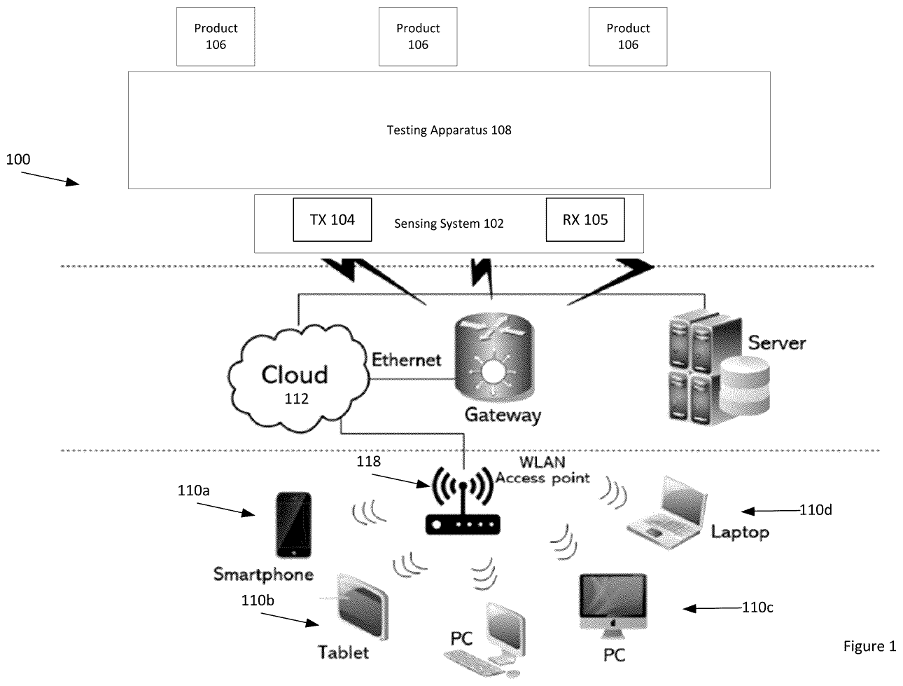

Turning to FIG. 1, a schematic diagram of an apparatus for use in examining a product (such as a liquid within a container) using microwaves or millimeter waves is shown. The apparatus 100 includes a sensing, or sensor, system 102, which may also be a near-field resonator or a mm-Wave radar device. The sensing system 102 includes at least one transmitter (Tx) 104 and at least one receiver (Rx) 105. The transmitter 104 is configured to transmit electromagnetic waves at a low or high frequency, such as a frequency generally between 1 GHz and 300 GHz or an appropriate subset of this frequency range, depending on the required functionality or the product being tested. In some embodiments, the at least one transmitter 104 may be a 2-channel transmitter configured to transmit millimeter waves between about 30 to about 81 GHz. The transmitter 104 transmits electromagnetic waves that are directed at a plurality of products 106, such as a container including a liquid or a container (or bag) including dry goods, to determine at least one characteristic of interest or to examine the contents of the product 106. In some embodiments, the container holding the liquids or solids, in the form of dry goods, may be examined by the sensing system 102. In other embodiments, the container or packaging may be a non-metallic material such as, but not limited to, plastic, glass or ceramic whereby only the item within the container is tested.

In one embodiment, the sensing system 102 is associated with, or mounted to, a testing apparatus 108 (such as, but not limited to, a conveyor belt system) that includes the components to enable the products 106 to travel and pass by the sensing system 102 in order for product (either or both of the item and container) to be examined.

In the current embodiment, the sensing system 102 is in communication with user interface and/or computing devices 110 such as, but not limited to, a Smartphone 110a, a tablet 110b, a personal computer (PC) 110c or a laptop 110d. It is understood that other computing devices may be contemplated. These computing devices may be seen as control stations. Communication between the sensing system 102 and any of the user computing devices 110 may be through a public network 112, such as the Internet, or may be via a private network. The system 100 may further include a gateway 114 and a server 116 for processing the information received from the sensing system 102. The user computing devices 100 may connect with the network 112 via a WLAN access point 118 although connection methods are contemplated.

In use, as the products (or objects) 106 pass by the sensing system 102 along the testing apparatus 108, electromagnetic waves are transmitted (via the at least one transmitter 104) towards the products 106 by the sensing system 102. These waves are then rebounded, scattered and/or reflected, off the product or products 106 and received by the receiver 105. Once the electromagnetic waves that have interacted with the product 106 are received at the receiver 105 (which may be in the form of raw data), the received signals are processed to generate data associated with these received signals. The generated data may represent a determination of at least one characteristic of at least one component of the product (either the food item or the container or both) or may be processed raw data that can then be processed by a computing device 110 to determine the at least one characteristic. The generated data is then transmitted to at least one of the user computing devices 110 or control stations.

In other embodiments, the control station may be a computer, a purpose-built device, or other device configured to receive and analyze the data. The control station or computing device 110 includes at least one processor configured to carry out computer-readable instructions with respect to the data received. The generated data may be reviewed and may have various processes or algorithms applied to it by the computing device 110. In some embodiments, a decision tree may be generated to better analyze the characteristics of the product based on the generated data. In other embodiments, other types of machine learning algorithms may be used such as, random forest, support vector machines (SVM), principal component analysis (PCA), recurrent neural network (RNN) or any other complex neural networks to determine the at least one characteristic based on the generated data.

A random forest classifier may be seen as a supervised machine learning algorithm that includes a collection of decision trees used to classify data into discrete categories. The decision trees work by mapping the observations of the product, such as the magnitude and phase of backscattered signals, to predictions about the target value of the object such as butterfat percentage concentration. At the end of the random forest process, the most recurring prediction reached by all decision trees is outputted as the characteristic's predicted value.

The system 100 (or the user computing device 110) may also include a memory component used for storing data, computer instructions, programs, machine learning and the like. Instead of being integrated within the user computing device 110, the memory component may be an external database, cloud storage or the like. The system may also include a display and/or other user interface components in order to enable a user to view and/or interact with results of the analysis.

As discussed above, the system may be used to examine liquids or solids within a container, such as a bottle, a carton, a bag and the like. In one embodiment, the liquid being examined is milk and the container is a cardboard carton. In other embodiments, the sensing system 100 may be used to test for a level of glucose.

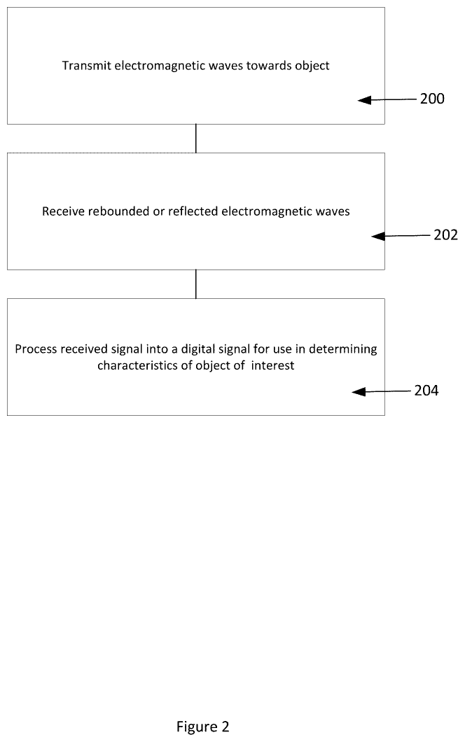

Turning to FIG. 2a, a flowchart showing a method of sensing and characterizing or determining characteristics of an object is shown. Initially, the sensing system transmits electromagnetic waves (via the transmitter) at or towards the object (200) and then receives rebounded or reflected electromagnetic waves via the receiver (202). Data associated with the received rebounded or reflected electromagnetic waves is then transmitted to the control station, such as in the form of a digital signal, digital data, or raw data (204). In some embodiments, the data may be the reflected signal or a series of reflected signals. In other embodiments, the raw data may be seen as data that is generated after the reflected signal is processed.

In one embodiment, a transmission signal is provided to the transmitter (such as via a transmitting antenna) via a radio frequency (RF) generator. In other embodiments, the signal is passed through a power divider to the transmitter. The reflected signal is received at the receiver (such as via a receiving antenna) and provided to a pre-amplifier. The signal is then combined with the signal from the transmitter (via the power divider) to provide for a result, via, for example, a mixer. The power divider may provide for signal adjustment prior to providing the signal to be combined. In some cases, the signal may be reduced/attenuated by 3 dB, although other adjustments/reductions in amplitude may also be used.

Once the signal results, or reflected signals, are obtained or received, the signal results may be filtered by a filter, for example a low pass filter. The signal may then be amplified by an amplifier and converted to a digital signal by an analog to digital converter. Once a digital signal is generated, it can be further transmitted to and/or processed by the control station.

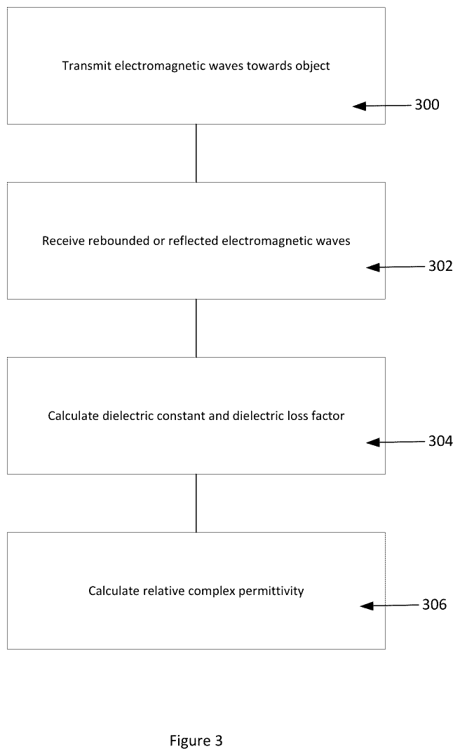

Turning to FIG. 3, a flowchart outlining a method of determining milk fat percentage in a low GHz band is shown. In one embodiment, the transmitter transmits electromagnetic waves in a low GHz band such as between about 1 GHz and about 10 GHz. In one embodiment, the disclosure is directed at a method and system for differentiating milk products of varying fat percentages while verifying their quality metrics using non-invasive microwave sensors operating in the low GHz spectrum. In determining the milk fat percentage (the at least one characteristic), it is assumed that the expected percentage of butterfat of milk is known and the system may be used to confirm that the milk contains the expected percentage butterfat. This may be performed with the milk in the container or out of the container.

Initially, electromagnetic waves in the low GHz band are transmitted, via the transmitter, towards the product (300) (such as a milk carton or a milk bottle containing milk) and the reflected electromagnetic waves are then received by the receiver (302).

In one embodiment, this may be performed using the system of FIG. 1 as the products pass by the sensing system when on the conveyor belt. In another embodiment, the transmitter and receiver may be integrated together in the form of a probe that operates in the low frequency band therefore covering (300) and (302) by placing the probe into the milk being tested. In this manner, the milk may be placed in a dish or bowl or the like. In yet another embodiment, the transmitter and receiver may be connected to a near-field resonator/sensor (e.g., split ring resonator, or its complementary) via coaxial cables. In this manner, the milk product may be tested on top of a specific sensing region by perturbing the induced/coupled electric field and modulating the received signal. In other embodiments, the at least one transmitter and at least one receiver is placed in a predetermined position with respect to the product being tested.

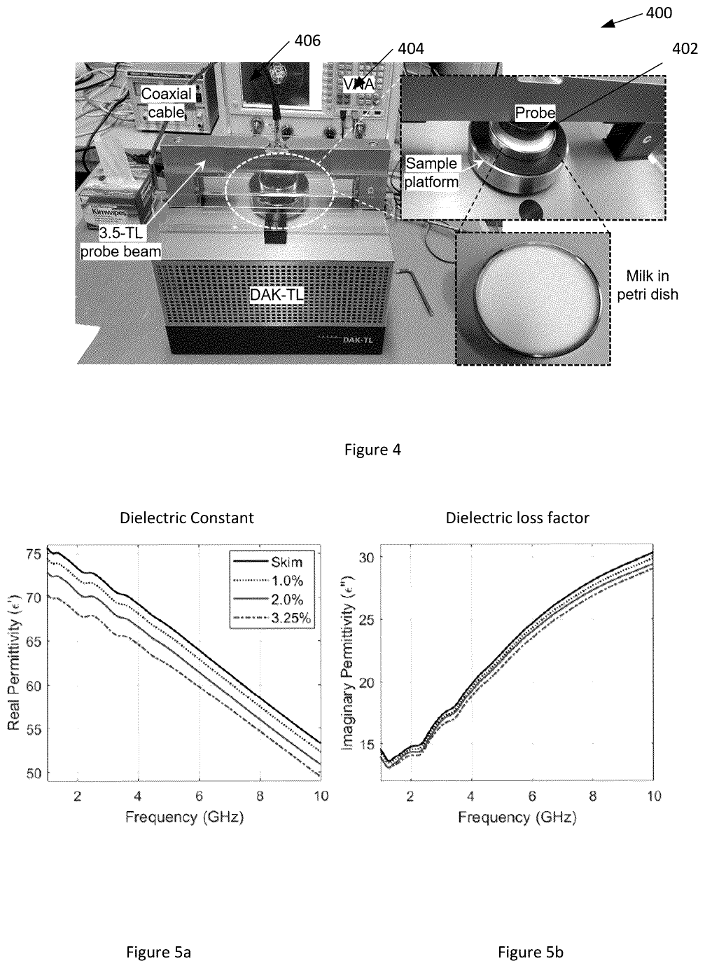

The received signals can then be processed (possibly with the transmitted signals) to generate a digital signal relating to a dielectric constant (ε′) and dielectric loss factor (ε″) of the milk product sample (304) in the low frequency band. The received signals may be processed by any one of the control stations or may be processed in the cloud and the resulting digital signal transmitted to the control station. The dielectric constant (ε′) and dielectric loss factor (ε″) provide an understanding of the dielectric dispersive behaviour of the milk at varying butterfat concentrations. The dielectric measurements may also be used to locate a region of most sensitivity to fat detection. In one embodiment, this may be achieved using a measurement setup such as shown in FIG. 4.

FIG. 4 provides a schematic diagram of another embodiment of an apparatus for testing using low range electromagnetic waves, for example to examine characteristics of a liquid. The current embodiment may be used to determine milk fat percentage.

The apparatus 400 includes a co-axial probe 402 (used for the measurement in (300 and 302)) that is connected to a port of a vector network analyzer (VNA) 404. The apparatus 400 further includes a central processing unit (CPU), such as a computer, 406 which includes a display. One example of a VNA is a Keysight Technologies VNA N5227A. In the current embodiment, the VNA 404 is connected to the CPU 406 via an Ethernet/LAN cable and the probe 402 is connected to the CPU 406 via a USB cable. Other setups are contemplated. For one experiment, calibration of the apparatus 400 was performed at 20° C. in the low frequency range using distilled water and an embedded Open-Short-Load methodology.

This apparatus 400 may be seen as a non-invasive testing methodology using complementary split-ring resonators (CSRRs) where testing is performed using resonant sensors in a sensitive narrow-band. In the current embodiment, four types of advances CSRRs were used with a vector network analyzer to non-invasively test and measure S₂₁ of the milk products.

In using the apparatus of FIG. 4, to obtain the dielectric constant (ε′) and dielectric loss factor (ε″), the probe is pressed against the milk product sample. In one specific embodiment, a 50 Ω coaxial probe is pressed against the milk product sample that was poured into a metallic petri-dish on top of an aluminum plate in the sample platform. A relative complex permittivity, which is a property for characterizing different materials, is then determined or calculated (306) from the measured reflection coefficient S₁₁, calibrated sample thickness, probe diameter, and bead permittivity using a built-in numerical algorithm. The dielectric constant (ε′), dielectric loss factor (ε″) and complex permittivity may then be further processed by a control station.

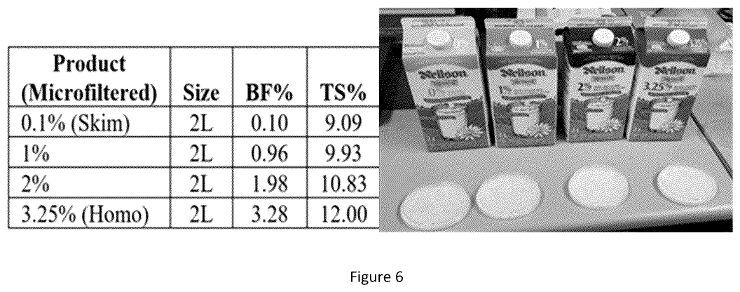

For experimental purposes, this was performed multiple times to verify repeatability of the dielectric measurements. The average of the extracted ε′ and ε″ for all trials is plotted in FIGS. 5a and 5b, respectively. As can be seen in the graphs of FIGS. 5a and 5b, for all fat contents, the dielectric constant ε′ decreases with increasing frequency almost linearly over the 10 GHz measured bandwidth. However, the dielectric loss factor ε″ has a decreasing pattern up to 1.3 GHz and then increases gradually with the increased frequency. Higher losses are expected towards higher frequencies as depicted in FIG. 5b. The changing trends of ε′ and ε″ with frequency is not influenced by the concentration of the butterfat, however, noticeable contrast in the properties values was observed between the varying-fat milks where both the dielectric constant and loss factor tended to decrease with increased fat content at any given frequency. ε′ was observed to change in larger resolution compared to those spotted in the ε″ trend. The 1-6 GHz frequency band was identified as a promising region for sensitive milk fat detection as demonstrated by the percent change in ε′ (≈2.0% for 1% butterfat change at 4 GHz). Characterization was also performed in the high frequency band 50-67 GHz with similar patterns identified in both ε′ and ε″, and therefore considered another promising sensitive region for milk fat detection. Milk characterization was performed in a controlled temperature environment of ˜20±1° C., yet both ε′ and ε″ are expected to decrease proportionally with increasing temperature.

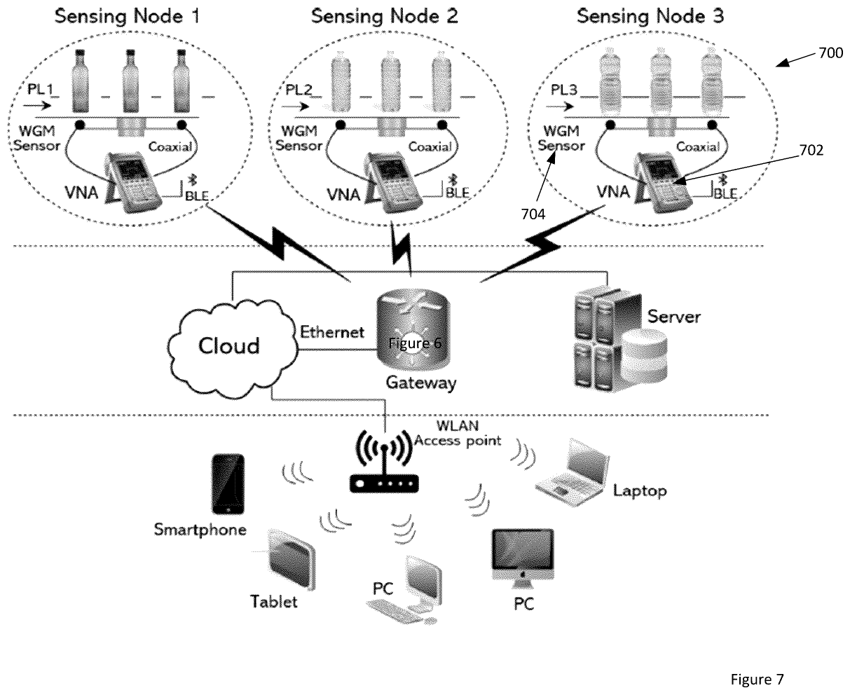

Using the method of FIG. 3 and the system of FIG. 4, the dielectric properties of four products of white milk Neilson™ dairy of the Microfiltered class: skim, 1%, 2%, and 3.25%, were investigated using a wide-band characterization system. The tested milk products are shown in FIG. 6 along with their sizes, butterfat %, and total solid target/content.

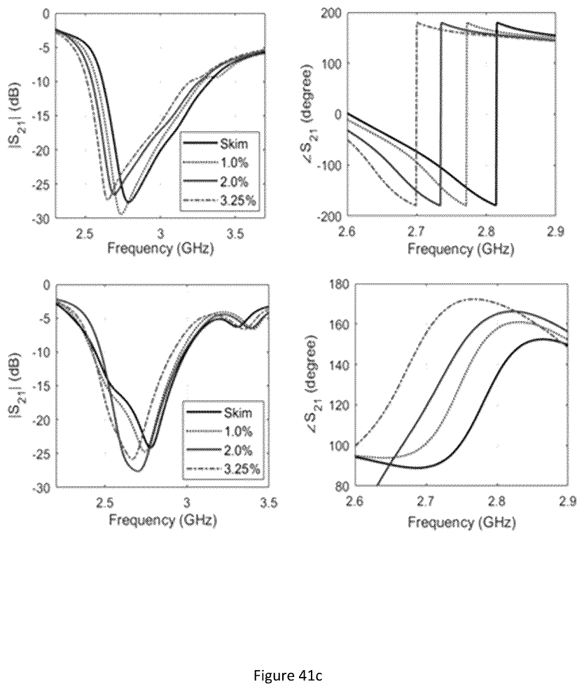

The fat-based differentiability was verified on four prototypes of advanced resonant sensors where the transmitter and receiver of the radar board were connected to a near-field resonator/sensor (e.g., split ring resonator or its complementary) via coaxial cables as schematically shown in FIGS. 41a and 41b. The samples of milk products were tested on top of the designed sensing region through perturbing the coupled electric field and thereby modulating the received signal of the sensor. As illustrated in FIG. 41c, the results of the measurements retrieved via the compact and dispersed honey-cell CSRR integrated sensor are shown.

In another example using the testing apparatus of FIGS. 41a and 41b, 2 ml (by volume) milk samples (in a circular container) were placed on top of the CSRR and then tested via the apparatus 400 three times to determine an average S₂₁ magnitude. During testing, the milk samples perturb the electric-field induced over the circular sensing region or the CSRR and modulates the S₂₁ resonance profile depending on the electromagnetic (EM) properties of the milk fat composition so that distinct amplitude and frequency variations near the bare resonance of the device were observed demonstrating the electromagnetic identification of the milk at varying fat%.

One of the types of CSRRs may be a single pole CSRR which includes a single pole of two concentric split-rings loaded in a microstrip substrate having specific geometrical parameters. Another type of CSRR that was used was a triple pole CSRR. In testing, similar transmission parameters were collected between 3.8-4.7 GHz by testing the milk samples again at 600 uL volume, but this time inside a rectangular container integrated on top of a CSRR of triple integrated poles. The CSRR caused the coupled electric-field to spread over a larger region due to mutual coupling between the three adjacent cells. The S₂₁ resonance profile was observed, and it was noted that it changed in both amplitude and frequency following the milk fat % of the tested milk samples. Another type of CSRR is a honey-cell CSRR which may be seen as a honey-cell configuration of a set, such as four, hexagonal CSRRs in a compact or dispersed formations. The milk samples (in small vials) were tested first on top of the compact formation CSRR and the S₂₁ was observed to significantly change both in co-efficient (between 2.5-3 GHz) and in phase (between 2.6-2.9 GHz). The milk products were tested again in larger vials on top of the dispersed formation CSRR sensor, and the same changing trends were observed in the coefficient (between 2.4-3.5 GHz) and in the phase (between 2.6-2.9 GHz). These results confirmed the ability of these sensors to non-invasively identify the milk samples at varying fat %.

In another embodiment, the disclosure is directed at a system and method of characterizing and/or sensing of oil characteristics in the mm-wave band. In this embodiment, the disclosure is directed at a compact, low-cost, miniaturized, and non-invasive mm-wave sensor to be integrated into an Internet of Things (IoT) based real-time sensing system.

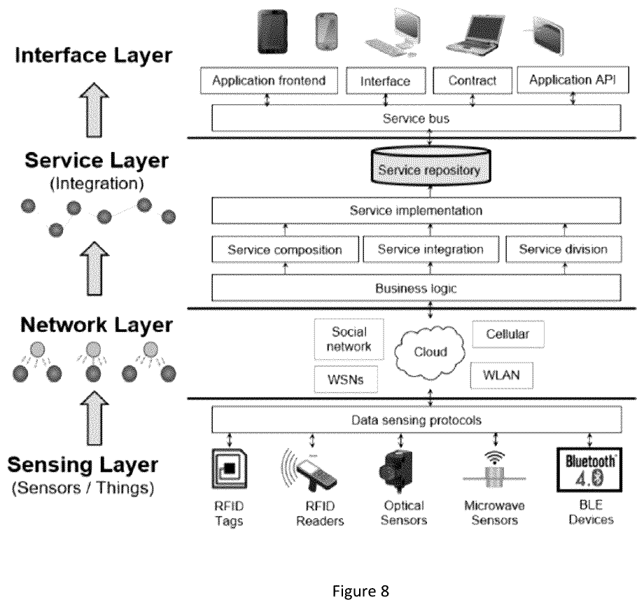

Turning to FIG. 7, a schematic diagram of an embodiment of a system for determining oil characteristics is shown. The sensing system 700 includes a VNA device 702 that is in communication with a sensor, such as, but not limited to, a whispering-gallery-mode (WGM) sensor 704. The system 700 further includes apparatus that is capable of transmitting and receiving electromagnetic waves such as in the form of a transmitter and a receiver as discussed above. As shown in the current embodiment, the system may include a plurality of testing apparatus, or sensing systems 700 that may operate in parallel in order to save time although, it is understood, that there may be a fewer or a larger number of testing apparatus. The other components of FIG. 7 may be identical to the components discussed in FIG. 1 and will be understood by one skilled in the art. It is understood that the system shown in FIG. 1 may also be used for determining oil characteristics.

In one embodiment, a sensitive WGM technique is used to implement the sensing platform in the mm-wave range of about 22 to about 32 GHz to induce high Q-factor resonances adequate for monitoring the oil quality and determining oil characteristics, such as, identifying its brand. In one embodiment, the core sensing structure couples the microwave power from a microstrip line to a ring resonator made of ferrite material of high resistivity and low loss. Its magnetic anisotropy is exploited to engender a non-reciprocal effect on the induced modal fields in the presence of a bias magnetic field. The acquired non-reciprocity feature is favorable to allow for checking the oil samples at multiple sensing instances of highly sensitive WGM modes at distinct frequencies in both S₁₂ and S₂₁ transmission signals. Particularly, sensing information is collected from three distinctive features of each excited WGM mode: 1) resonant amplitude; 2) resonant frequency; and 3) phase transition occurring near resonance. Combining these sensing parameters enable a robustness and reliability of the measured data by minimizing, or reducing the associated uncertainties received from the background noise, ambient environment, interconnected instrument, etc. The functionality of the system is practically demonstrated by identifying edible oils of different types and brands whose electromagnetic differences were imprinted in the S₁₂ and S₂₁ signals of the sensor.

Given its miniaturized sizing (approximately 6 cm³), the WGM sensor may be easily adapted as a low-cost portable tool for rapid real-time identification of the oil type, on-site EM analysis, and quality checking for regulations compliance and food quality control purposes. FIG. 7 depicts the implementation of the sensor in three sensing nodes, where in each sensing system, the sensor is installed at one hot spot a few millimeters underneath the production line (or testing apparatus) where all the oil products pass through. The interaction of the electromagnetic field generated by the sensing system with the oil material on top of the ring resonator allows for a recording of its scattering response in a short time frame (such as a few seconds) by the VNA. The scattering response may also be analyzed and compared against a reference response using an artificial intelligence (AI)-based software.

In another embodiment, the oil sample may be exposed to the sensor before packaging to monitor its quality and thereafter upon regulation to report any fraudulent brands and/or producers. The sensor could also be used for identifying the adulteration in virgin olive oil and distinguish similar oils of notable differences in quality. The electromagnetic resonance profile of the pure extra virgin olive oil would be slightly different from those been adulterated as detected by the device circuitry.

Some advantages of this embodiment include the fact that the sensing structure enjoys many features of low power consumption, affordable cost, and high sensitivity, thereby making it attractive not only for development as an independent quality detection platform but rather as a complete autonomous system based on IoT for implementation as online, rapid, noninvasive, and cost-efficient measurement system in the oil processing industry where no such system is yet implemented or commercialized.

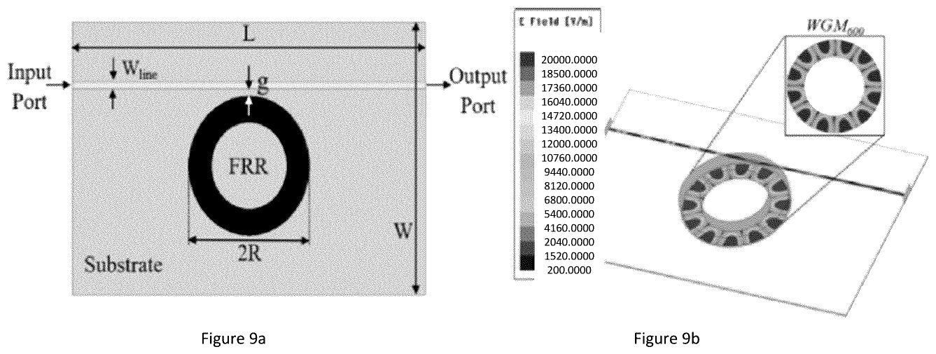

In another embodiment, the sensing system may be seen as an integrated IOT system, such as schematically shown in either FIG. 1 or FIG. 7. The system may be seen as a service-oriented architecture (SOA) that demonstrates higher effectiveness for implementation in smart systems, featuring advantages in defining a simple ecosystem where all entities are well defined. FIG. 8 shows one structure of a SOA in terms of four consecutive layers starting at the sensing layer where the WGM microwave sensor operates. The other three layers include network, service, and interface layers.

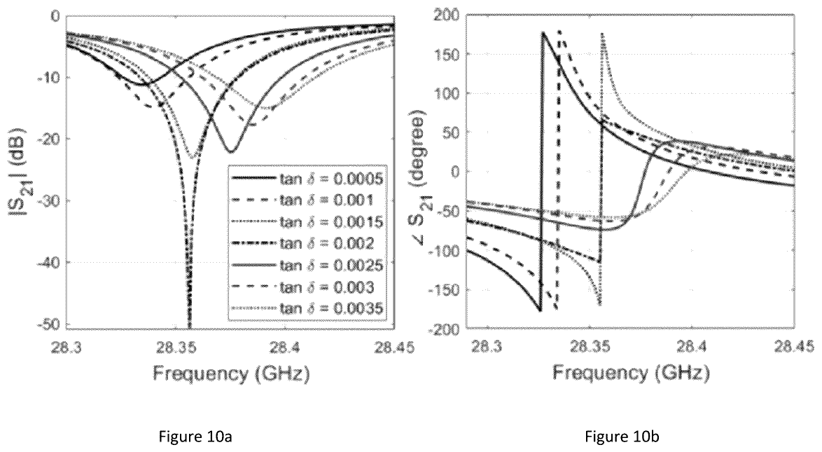

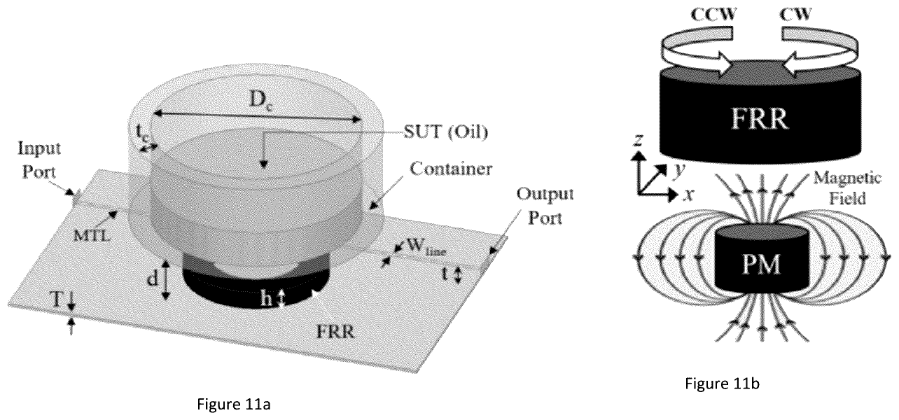

With respect to a sensing layer, the sensor may include a ferrite ring resonator (FRR) and a microstrip guiding structure (MTL) both combined on top of a dielectric PCB as shown in FIG. 9a. The FRR may be installed within a few micrometers (seen as gap g) of the MTL edges to realize a desired coupling. Consequently, the MTL links the modal fields to the adjacent FRR to excite the WGM modes where the coupled waves propagate azimuthally around the FRR in multiple rotations that are phase shifted by 2πn, where n is an integer representing the number of rotations. The resulted traveling waves experience repeated reflections from the inner rims of the FRR, and thereby, the E-fields remain confined and highly concentrated toward the outer boundary as depicted in FIG. 9b for the electric field distribution of the sensor.

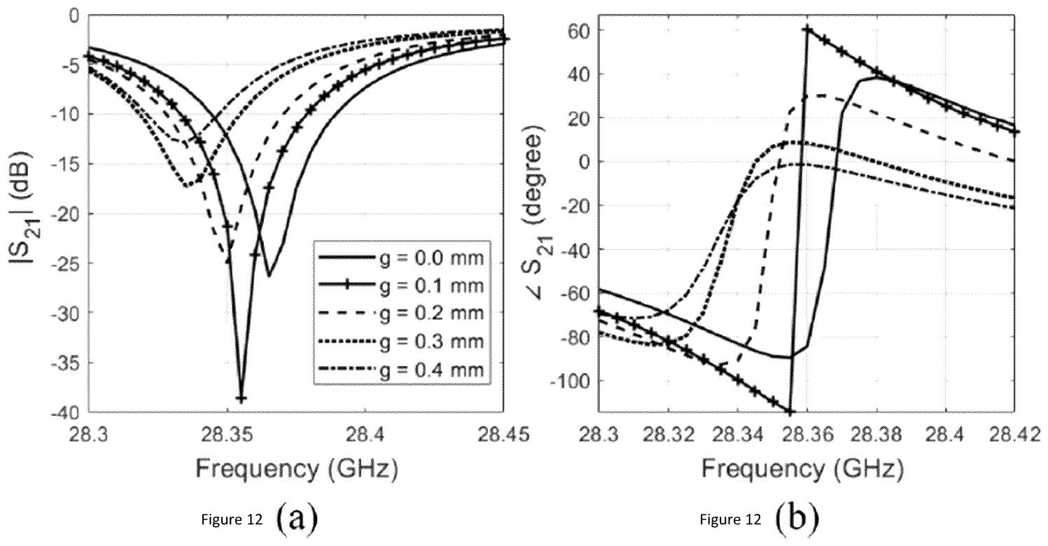

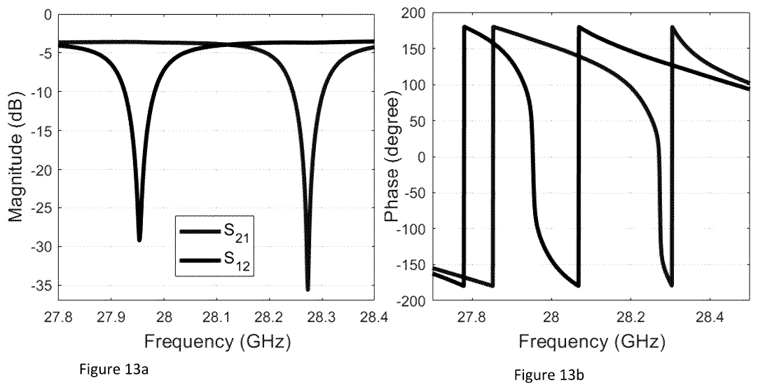

In use, the sensor attains a high degree of sensitivity to changes in loss property of its FRR component, which vary its coupling level accordingly. This-behavior of high sensitivity to changes in the loss property will yield the sensor very responsive (in terms of resonance characteristics) to the little perturbations in the electromagnetic properties of various oils loaded on top of the FRR very close to its boundaries as shown in FIGS. 11a and 11b.

As shown during experimentation, the diverse oils contain several fatty acids that differ in relative percentages depending on their type and origin. In fact, each edible oil is essentially a mixture of triacylglycerides (TAGs), which are fatty acids esters of the trihydric alcohol glycerol with three alkyl chains contained in each molecule. The physical and chemical attributes of each oil are mostly affected by the C₁₈ unsaturated fatty acids (UFAs) in their composition. The dielectric constants ε′ of oils were shown to be significantly determined by their UFAs composition where ε′ increases with increasing the relative degree of oils unsaturation (i.e., the number of double bonds in carbon chain) as shown by the iodine values (IVs). Therefore, minimal differences are expected within the electromagnetic (EM) properties of each oil sample. Oil and water were found to have quite different values of dielectric constants (≈3.1 and 77.0, respectively, at 1 MHz and 25° C.). Apparently, water polar molecules have energy storage that is much greater in magnitude than oil molecules. This energy is stored due to the orientation and polarization of the polar molecules under the exposure of the applied E-field. Therefore, it is expected that ε′ of oils would significantly increase with increasing the moisture content. The frequency, temperature, and other chemical characteristics, such as volatile ratio, solid-fat index, etc., would also impact the EM profile for oils. Analyzing the scattering response of the WGM sensor will benefit a sensitive identification of various oil types and the detection of any impurity imbedded in the loaded oil samples where the EM properties are slightly modulated.

The sensor of this embodiment was designed to operate in 22-32 GHz to keep a size of the sensor compact with a wavelength resolution in the range 0.9-1.4 cm that is sufficient or adequate for more sensitive interaction of the WGM waves with the loaded oils. However, it may be desirable to enhance the structure sensitivity through a stronger coupling between the MTL and FRR. In some embodiments, the sensor may be designed to operate at higher frequencies such as up to about 70 GHz. In other embodiments, the WGM resonator could also be interconnected to a radar printed circuit board as a driving source instead of the VNA.

In some embodiments, the nonreciprocal operation of the FRR was triggered to acquire more sensitive instances of WGM resonances in both the S₁₂ and S₂₁ signals. To do so, a permanent magnet (PM) was attached beneath the substrate to induce the necessary biasing magnetic field perpendicular to the plane in the z direction as portrayed in FIG. 11b. When such a biasing field is present, the magnetic dipoles inside the ferrite resonator are aligned in either clockwise (CW) or counter-CW (CCW) direction to produce non-zero magnetic dipole moment that motivates dipoles precession at a frequency controlled by the strength of the applied magnetic field, thereby turning the singular permeability of the ferrite resonator into a nonsymmetrical tensor due to its activated magnetic anisotropy. The effect of this tensor will be seen as two effective permeabilities μ⁺ and μ⁻, for the (CW/+) and (CCW/−) travelling WGM modes of similar radial “n,” azimuthal “m,” and axial “I” variation. As a result, they would exist at two different resonance frequencies in the S₂₁ and S₁₂ signals.

The final layout of the sensing structure integrates an MTL of width Wₗᵢₙₑ=0.28 mm and thickness t=0.017 mm on top of a Rogers 4360G2 substrate (ϵ′=6.15, tan δ=38×10⁻⁴) of length L=30 mm, width W=20 mm, and thickness T=0.2 mm. A ferrite material (ϵ′=13.2, tan δ=4×10⁻⁴) was used to design the ring resonator of radius R=5.13 mm and height h=1.44 mm. A PM (Samarium-Cobalt) of height H=3 mm and diameter D=9.8 mm was integrated in the ground plane of the microstrip substrate. Other magnets of varying sizes depicted could also be used with the FRR to realize a compact layout.

Other devices could be used in this sensing layer (e.g., FMCW mm-wave radar, split ring resonator (SRR), CSRR, antenna array, or combination of them for enhanced sensitivity performance)

The network layer provides the necessary wireless network connectivity to acquire the oil sensing data from each sensing node, process, and share it among different units in the decision level. Applied communication technologies should satisfy the requirements of flexibility, compactness, widespread compatibility, reasonable data rate, low cost, and energy consumption. Radio-frequency identification (RFID) is one technology that delivers M2M communication with passive tags of favorable specifications; however, it is more suit-able for other applications that are identification oriented. ZigBee (based on IEEE 802.15.4 standard) is another option that suits applications of low energy consumption, low data rate, and long transmission coverage. The wireless local area network (WLAN) or WiFi operating in the frequency bands of 2.4 and 5 GHz is among the candidates that provide higher data rates (˜150 Kbps) and longer coverage (up to

100 m) especially in the new variants of the IEEE 802.11 standards [34]. However, it requires much higher power for RF transmission when integrated with the sensing platform. Among all the aforesaid technologies, Bluetooth low energy (BLE) is shown to have a match for the intended industrial application for many favorable features, such as lower energy consumption, lower sleeping interval (˜10.0 s), moderate data rate, available firmware, and broad compatibility with different operating systems.

Every node represents the sensing operation performed at one PL using at least one WGM sensor connected to an RF network analyzer or possibly a radar printed circuit board (PCB) through a pair of coaxial cables. The function of the analyzer is to inject the microwave signal into the sensor and read out the output scattering signal (i.e., response). The raw sensing data are to be sent over the BLE radio network module to the gateway using a BLE-adapter and firmware that is compatible with the employed analyzer. The gateway component collects the oil sensing data over the BLE radio network and then sends it over the Ethernet interface to the Internet cloud. In fact, it is pivotal to secure the sensing data before its delivery to the cloud. Therefore, appropriate policies in encryption, authorization, and authentication are all applied at the gateway level to enable the data access only for authorized users. The gateway could be implemented using a Raspberry Pi platform of low cost, small size, high integration, and good performance.

The service layer demands much of the resources in the SOA architecture, such as power consumption, processing time, etc., to perform the necessary tasks of highly complex computations. It is desired to select an efficient approach that assures an independent local operation yet features a global functionality to allow for real-time automation. The workstation also incorporates advanced data analytics modules where some machine learning algorithms, such as, but not limited to, support vector machine (SVM), principal component analysis (PCA), convolutional neural network (CNN), etc. may be effectively used to enhance the productivity of the manufactured oil products while satisfying the regulatory requirements. Other machine learning algorithms may include time series random forest (TSF), a recurrent neural network (RNN), a gated recurrent unit (GRU), long short-term memory models (LSTM), or a complex neural network. In an actual implementation, this layer would be implemented completely in the cloud.

The end users could interact with the sensing system or apparatus through a system interface that is easy to use, such as, but not limited to, Laboratory Virtual Instrument Engineering Workbench (LabView) to develop a customize application that presents the measured sensing data collected from the noninvasive sensing nodes in visual plots and enumerated tables. Using the system interface, the raw data could also be processed, analyzed, and shared over the Internet to remote users accessing the system. To maintain the system integrity, the proxy modality could be employed for managing the accessibility of authorized users only at one centralized point where the user authentication, authorization, and security frameworks are strictly imposed.

In experimentation, to probe into the feasibility of the oil quality monitoring system for industrial implementation, the developed prototype was experimented in the microwave lab environment for identifying commercial oil products of different brands and types, namely, selection sunflower (A), selection canola (B), selection vegetables (C), selection peanut (D), mazola canola (E), and colavita olive (F), which were all purchased from one grocery store. The names and labels will be used interchangeably in the following demonstration.

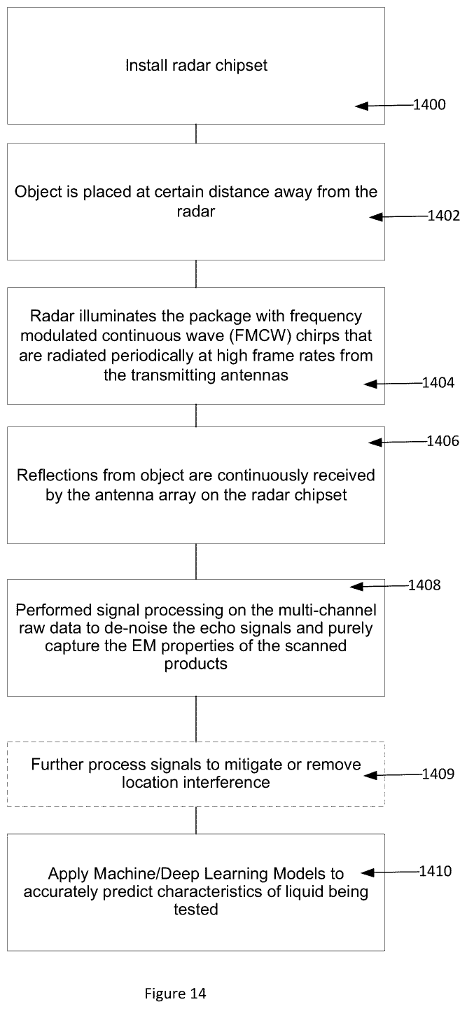

The oil measurements were performed when operating the sensor in the WGM₆₀₀ mode. FIGS. 13a and 13b depict the unloaded WGM₆₀₀ response (magnitude and phase) of the sensor at both S₂₁ and S₁₂. The resonance frequency and Q-factor for the operating WGM₆₀₀ is highest when no oil sample is yet introduced in the sensing zone of the FRR (i.e., baseline). The change in this reference response of the sensor at the two resonant peaks in S₁₂/S₂₁ and phases were used to track the quality of the tested oils.

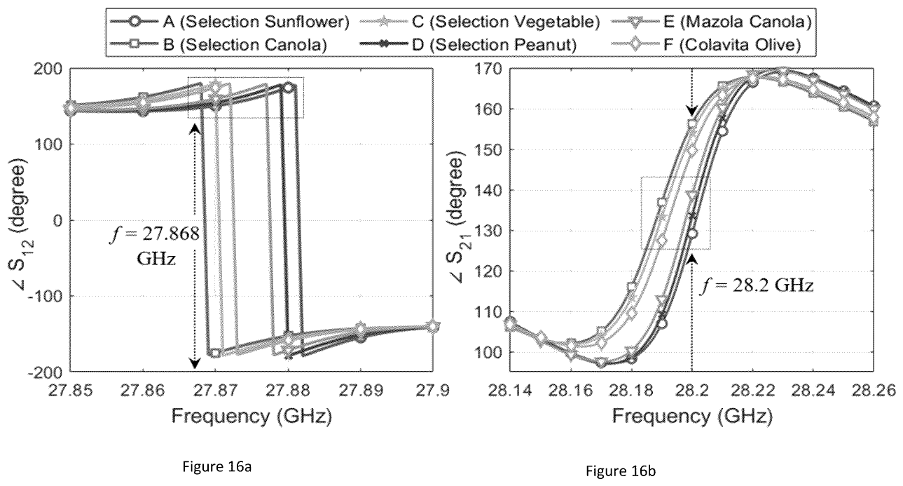

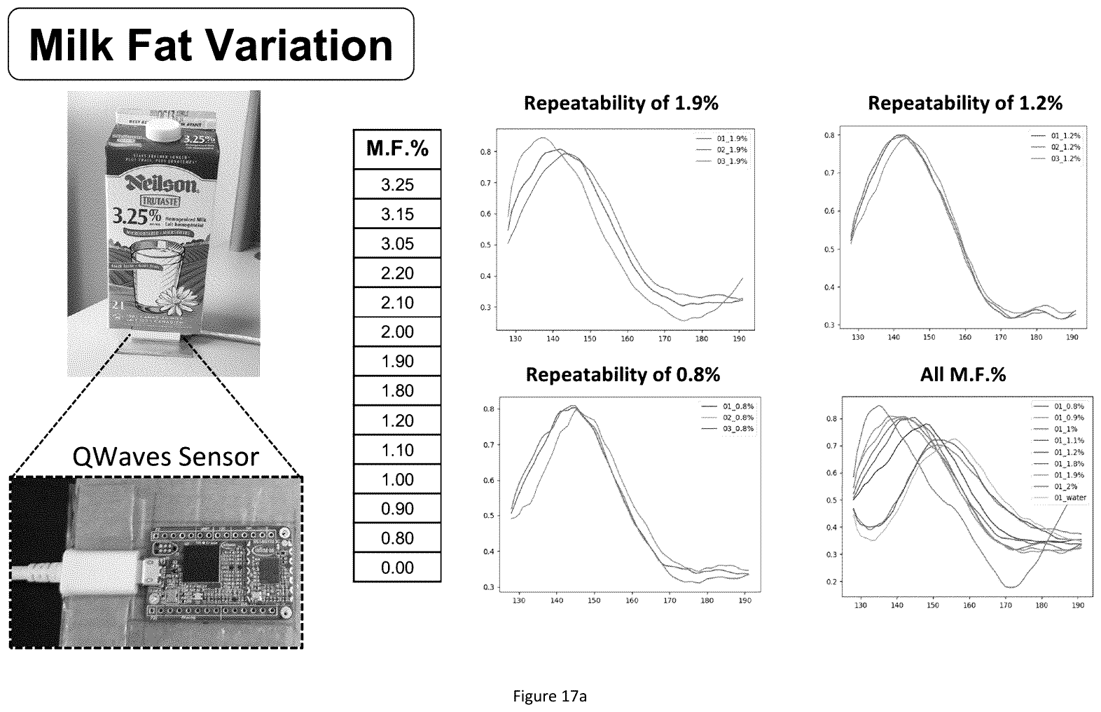

The six different oil products were measured on top of each sensor at very close proximity d=1 mm from the FRR. The baseline response in FIG. 13 was retrieved after measuring each oil bottle to ensure reliable comparison and repeatability. The WGM₆₀₀ responses to the six oil samples are compared in FIGS. 15a and 15b and FIGS. 16a and 16b, in terms of the |S₁₂|, |S₂₁|, ∠S₁₂, and ∠S₂₁, respectively. Each plotted response is an average of three repeatable measurements for the specific oil under test.

With their slight contrast in permittivity and losses, the oil samples perturb the coupled FRR evanescent fields differently. Remarkably, each oil sample is captured in the |S₁₂| and |S₂₁| responses with distinctive shift in resonance frequency and amplitude/depth as depicted in FIGS. 15a and 15b, respectively. A significant difference of about 8 MHz was detected between the S₁₂ resonances of the Canola oil from two different brands (Selection and Mazola). It was also seen as 9 MHz difference between their corresponding S₂₁ resonances. Additionally, the oil sensing information are considerably expanded by the scattering phases of S₁₂ and S₂₁ to allow for more precise identification of the oil samples. FIG. 15a shows that S₁₂ phase responses to various oils have distinct frequencies where the phase slopes abruptly change.

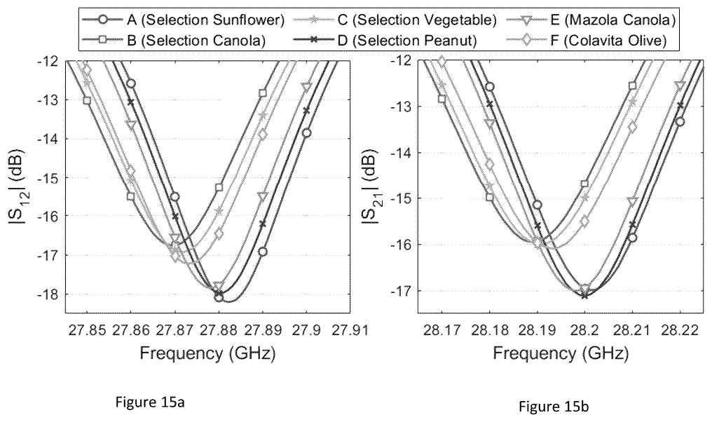

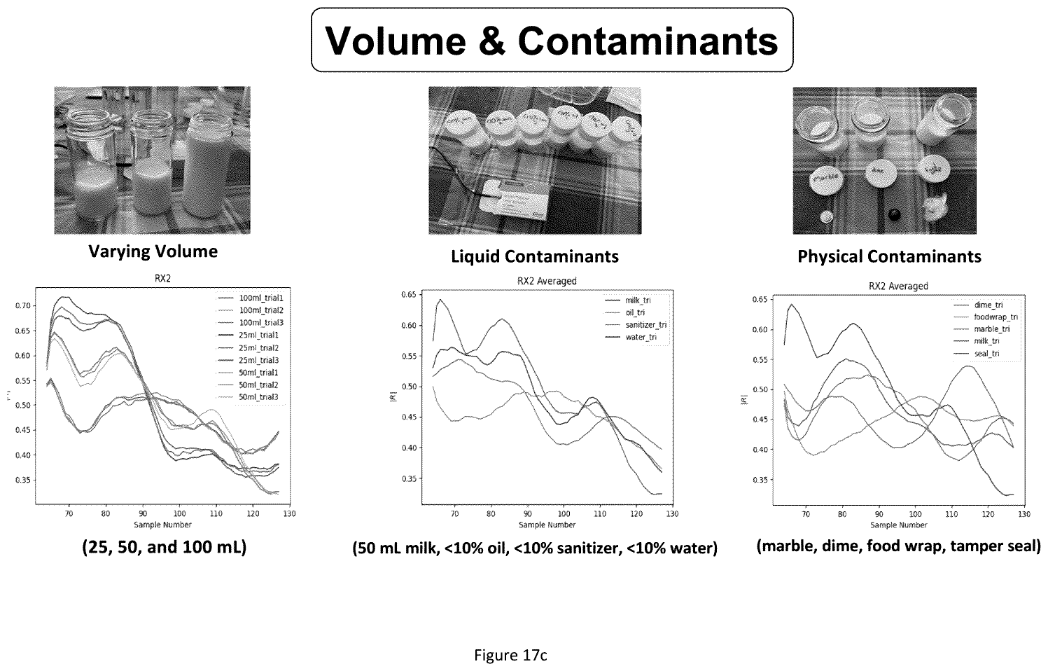

Turning to FIG. 14, another method of testing using low range microwaves is shown. In some embodiments, a single product is placed directly in front of a sensing system. In other embodiments, the product (combination of liquid and container) being tested is placed on a conveyor belt that moves the container past a sensing system that is mounted or positioned for transmitting and receiving electromagnetic waves at and from the liquid and container being tested. In some embodiments, this method may be used with respect to the setup of FIG. 18 below.

Initially, a sensing system, such as in the form of a radar or radar chipset, is installed, such as on a rod or fixture (1400). In one embodiment, the installation is at a predetermined height in accordance with a position of the object being tested. The radar chipset may include at least one transmitter and at least one receiver for transmitting EM waves and for receiving reflected EM waves, respectively. Alternatively, the object may be placed on top of the radar where the object is in contact with a surface of the radar or a short distance above the surface of the radar. If a conveyor belt is being used in the testing, the product may travel on the conveyor belt in front of the sensing system and, in other embodiments, the product may travel over the sensing system whereby the sensing system may be mounted within or integrated with the conveyor belt.

In other embodiments, multiple sensing systems may be installed at different positions and angles with respect to the container being tested and/or the conveyor belt, such as for quality monitoring, full scanning and/or sensing. In yet another embodiment, such as for food manufacturing production lines, positioning of the one or more sensing systems may be selected to scan packaged products when passing by on conveyor belts.

After installation of the sensing system, the object being tested is placed at a predetermined distance away from the sensing system (1402) or the product is moved past the sensing system by the conveyor belt. In some embodiments, the predetermined distance may be handled by the location of the sensing system with respect to the testing apparatus. In other embodiments, the object being tested may be manually placed the predetermined distance away from the sensing system. In other embodiments, the object, such as a milk carton, is placed inside a 3D-printed fixture to help maintain a stable position for the object during radar measurements (or when the EM waves are transmitted towards the object). In further embodiments, the conveyor belt is started so that the products that are located atop the conveyor belt travel past the sensing system.

The sensing system then illuminates the product with a high frequency modulated continuous wave (FMCW) (1404) or EM waves. In one embodiment, the sensing system transmits FMCW chirps that are radiated periodically at high frame rates. In some embodiments, the number of transmitting and receiving antennas (or transmitters and receivers) may vary and in different array installations (e.g., 3×4, 1×3, or other larger arrays) to increase the sensitivity resolution. The sensing system may also be integrated with off-board antennas, passive/active resonator, or dielectric lens to boost the detection sensitivity of the targeted objects (or fluid packages).

The reflected signals are then received or sensed by the receiver (1406). In some embodiments, the reflected signals (or reflections) from the product are continuously received by one of the receivers within the sensing system. These reflected signals may represent a store, or cache, of information that describe various attributes (thickness, volume, internal synthesis/composition, etc.) with respect to the object(s) (i.e., packaged product) based on the radar transmitted EM waves. The reflected signals may be received over a predetermined time window or time period.

The received EM signals are then filtered to retrieve raw data from each of the receiving channels during the time window (1408). The raw data may include information relating to various attributes of the liquid within the container. These attributes may include, but are not limited to, thickness, volume and/or internal synthesis/composition. In some experiments that were performed using the method of FIG. 14, milk samples of homogenous composition but with different amounts of butterfat percentages were tested in order to determine butterfat percentages of the milk within the container to confirm that the packaging label was correct. In these experiments, all the samples had a similar shape, volume, placement, and almost the same composition except for the concentrations of the butterfat that have tiny variations from one sample to another. The variation in butterfat percentage modifies the dielectric properties of the product, thereby making it possible for the radar signals to capture the unique signature of any deviations from the benchmark or target butterfat percentage. Particularly, tiny changes in compositions are perceived as changes in the amplitude and phase of the radar echo signals. In other studies, physical and liquid contaminants were added to different products in order to determine a purity of the liquid within the package.

In the specific embodiment of testing butterfat in milk samples, the variation in butterfat percentage modifies the dielectric properties of the sample/product in place, thereby making it possible for the radar signals to capture the unique signature of any deviations from the benchmark percentage Particularly, tiny changes in compositions are perceived as changes in the amplitude and phase of the radar echo signals.

The raw data is then further processed using signal processing methodologies (1408). This processing may be performed using sample gating, continuous wavelet transforms (CWT), empirical mode decomposition (EMD), discrete wavelet transform (DWT), short-time Fourier transform (STFT), fast Fourier transform (FFT), power spectral density (PSD) or other known signal processing methodologies. In one embodiment, the processing denoises the echo signals to extract a peak zone of each of the received reflected signals to capture material dependent properties of each of the scanned products. In other embodiments, the peak zone that is extracted is around the maximum received signal strength (RSS) which is then filtered and processed to extract further features of the liquid. In other embodiments, the signal processing is used to de-noise the echo signals so that the EM properties of the reflected signals can be purely captured.

In some embodiments, the signals may then be further processed to mitigate or remove location interference (1409) such as by using the range and the angle of arrival (AoA) of the sensing systems. This is shown in dotted lines indicating that this may not need to be performed in each embodiment.

Properties of interest may include, but are not limited to, predicting milk fat percentage or any deviations. For the testing of milk, by recording the multi-channel raw radar signals that are unique to various products/samples, and analyzing all using signal processing and machine learning algorithms, the system of the disclosure demonstrated the radar sensor capability to identify different milk products, detect any deviation from the quality benchmark, predict the milk fat percentage, detect any volume variation, detect any liquid contaminants mixed with milk and detect any physical contaminants inside milk. The method of FIG. 3b may be used for packaged fluids such as, but not limited to, milk, edible oil, carbonated beverages or juices.

The further signal processed signal can then be processed or applied to machine and/or deep learning models (1410) to predict and/or determine characteristics of the liquid or object being tested or identify the property of interest. Properties of interest may include, but are not limited to, predicting milk fat percentage or any deviations. In one embodiment, with respect to testing of butterfat percentage in milk, by recording the multi-channel raw radar (or reflected) signals that are unique to various milk products/samples, and analyzing them using signal processing and machine learning algorithms, the radar sensor capability to identify different milk products, detect any deviation from the quality benchmark, predict the milk fat percentage, detect any volume variation, detect any liquid contaminants mixed with milk and detect any physical contaminants inside milk was demonstrated.

Example models may include support vector machine learning, convolutional neural networks, recurrent neural networks or long short-term memory models. In some embodiments, a relative complex permittivity may be processed to determine a characteristic of the packaged milk. As will be understood, the method of FIG. 14 may be applied to all packaged fluids (milk, edible oil, carbonated beverages, etc.).

In a further embodiment, results from the method of FIG. 14 may be checked against specific benchmarks to provide a digital assessment and immediate actionable recommendations. The latter may be used to quickly synchronize a main fluid tank in a facility to ensure a rapid automated quality testing on product manufacturing. That would substantially reduce the products processing losses, labour shifts, operational costs, and effectively improve product quality and supply-chains.

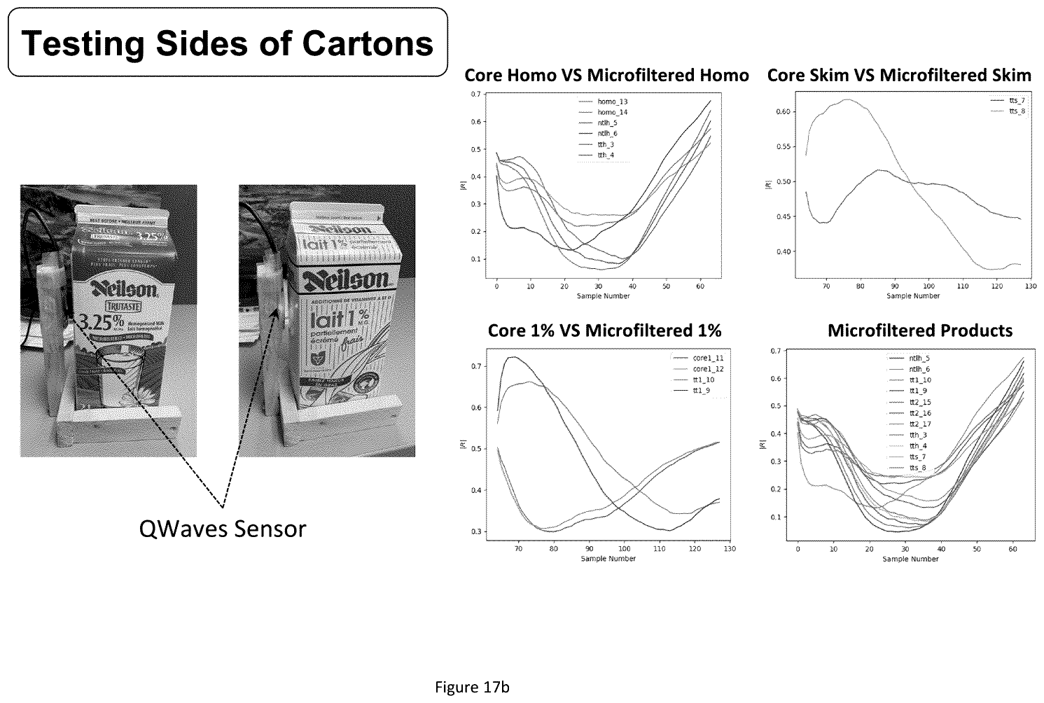

In one specific embodiment, a radar sensor operating between 58-63 GHz was developed and initially deployed to test milk cartons at known fat percentages. Each carton was measured by the sensor 3 times to confirm the repeatability of the device. The collected sensor responses have demonstrated the differentiation between tested cartons of varying fat concentrations from 0.8 to 3.25%. Ultimately, the system to be installed should be able to detect any deviation from the specific fat concentration of the milk cartons in that line. Results are shown in FIGS. 17a to 17c. FIG. 17a shows results for milk fat variation testing, FIG. 17b shows results for sides of cartons testing and FIG. 17c shows results for volume and contaminants testing.

In further experimentation, testing of 1% and 3.25% milk cartons was performed along with the testing of skim and 2% milk cartons. In the experiment, three separate trials were performed with three different cartons such that there were fifteen (15) tests for each type of milk. The top nine (9) tests were recorded (as outlined below).

In the conveyor belt experiment setup, the radar 1800 was set up in proximity to a conveyor belt 1802 such that when milk cartons 1804 passed the radar, there was about a two (2) cm radial distance between the radar 1800 and the carton 1804. This is schematically shown in FIGS. 18a and 18b. FIG. 18a shows the position of skim milk cartons 1804 on the conveyor belt 1802 with respect the radar 1800 and the FIG. 18b shows the position of 2% milk cartons 1804 on the conveyor belt 1802 with respect to the radar 1800. FIG. 18c is a schematic diagram showing a distance of each milk carton with respect to the installed radar. Using a conveyor belt speed of 20 (which results in a linear speed of 0.143 m/s), carton 1 passes the radar at t1=874 ms, carton 2 passes the radar at t2=2000 ms and carton 3 passes the radar at t3=3111 ms.

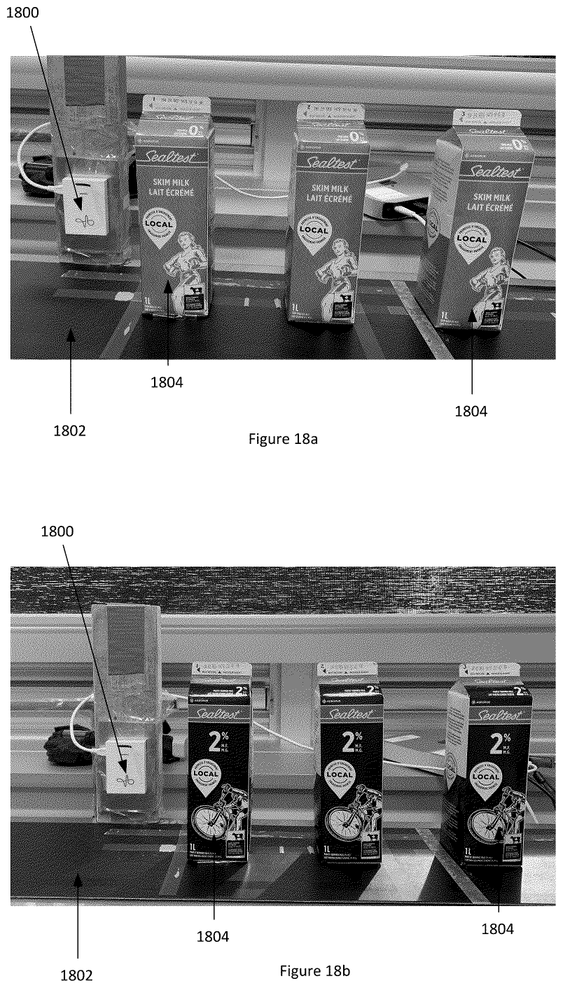

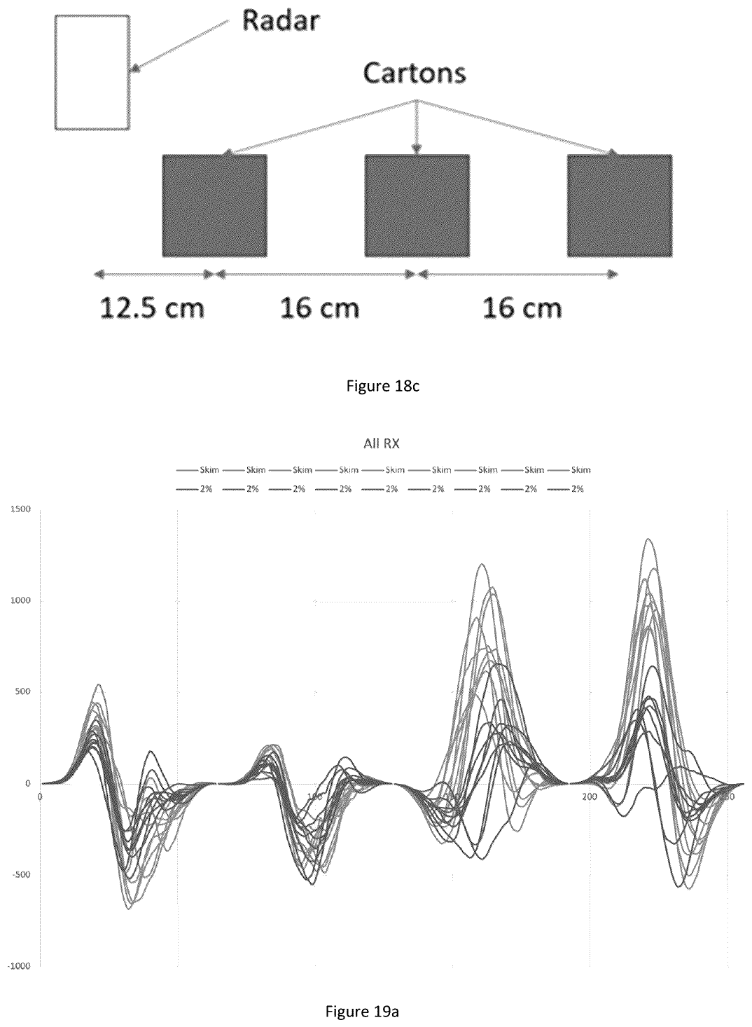

Results are shown in FIGS. 19a which provides a comparison of the testing results between the skim milk cartons (orange color) and the 2% milk cartons (blue color). Along the x-axis is radar channel bins (in the fast-time) and along the y-axis is the signals magnitude

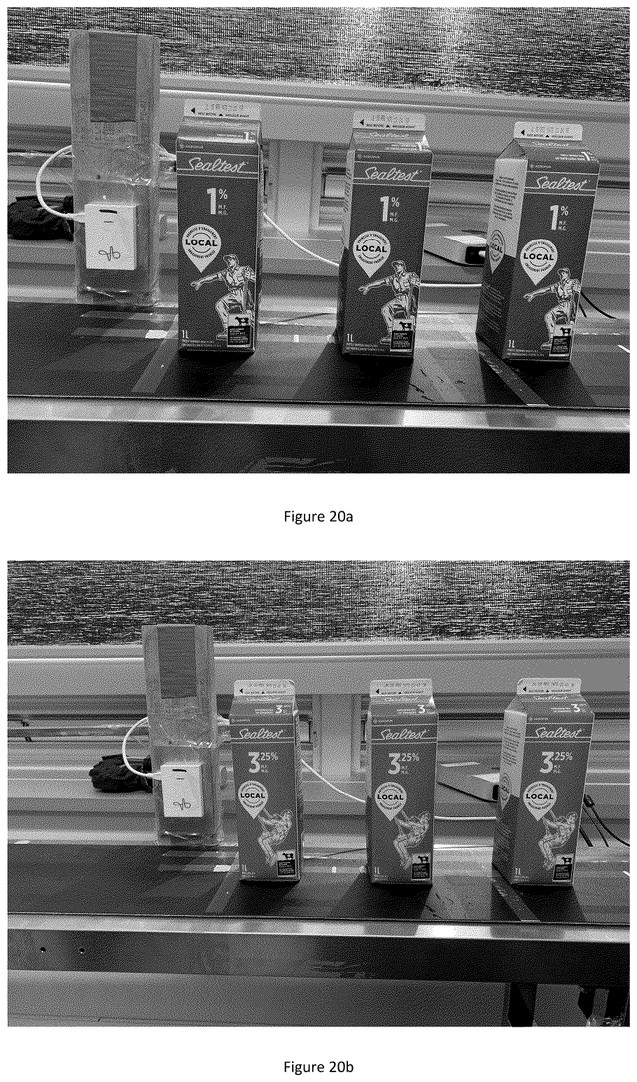

Testing for the 1% and 3.25% milk cartons was set up in an identical manner as discussed above with respect to the skim and 2% milk cartons. FIG. 21a provides a chart comparing all of the different milk and milk cartons that were tested. As shown, the radar would identify different milk products with unique amplitude variations for each milk.

In reviewing the different data that was received during a 1^{st} pass of the experiment, 36 measured samples were reviewed resulting from 9 trials for each milk product. This was received via 256 data features from 4 receiving channels. There was a random split of 80% (twenty-eight samples) of the samples were for training and 20% (eight samples) of the samples were for testing.

As can be seen in Table 1 (which represents the data from a 1^{st} pass or shuffle):

| Test Sample | True Label | Prediction |
|---|---|---|
| 1 | 2% | 2% |
| 2 | 1% | 1% |
| 3 | 2% | Skim |
| 4 | Skim | Skim |
| 5 | 1% | 1% |
| 6 | 3.25% | 3.25% |
| 7 | Skim | Skim |
| 8 | Skim | Skim |

As can be seen, during the 1^{st} pass the radar was correct 88% of the time with its testing whereby only one sample was misclassified.

In a second pass or shuffle of the experiment, 36 measured samples were used, and 9 trials preformed for each milk product. The data was received via 20 PCA features from 4 receiving channels (where there was a dimensionality reduction from 64 to 5 for each reaction). There was a random split of 80% (twenty-eight samples) of the samples were for training and 20% (eight samples) of the samples were for testing.

As can be seen in Table 2 (which represents the data from a 2^{nd} pass or shuffle):

| Test Sample | True Label | Prediction |
|---|---|---|
| 1 | 1% | 1% |
| 2 | 3.25% | 3.25% |
| 3 | 3.25% | 3.25% |
| 4 | 1% | Skim |
| 5 | Skim | Skim |
| 6 | 2% | 2% |
| 7 | 2% | 2% |
| 8 | Skim | Skim |

As can be seen, during the 2^{nd} pass the radar was correct 88% of the time with its testing whereby only one sample was misclassified.

In a third pass or shuffle of the experiment, 36 measured samples were used, and 9 trials preformed for each milk product. This was received via 256 data features from 4 receiving channels. There was a random split of 70% (twenty-five samples) of the samples were for training and 30% (eleven samples) of the samples were for testing.

As can be seen in Table 3 (which represents the data from a 3^{rd} pass or shuffle):

| Test Sample | True Label | Prediction |
|---|---|---|
| 1 | 3.25% | 3.25% |
| 2 | 3.25% | 3.25% |
| 3 | 2% | 2% |
| 4 | Skim | Skim |
| 5 | 1% | 1% |
| 6 | 1% | 1% |
| 7 | Skim | Skim |
| 8 | Skim | Skim |
| 9 | 3.25% | 1% |
| 10 | 2% | 2% |
| 11 | 1% | 1% |

As can be seen, during the 3^{rd} pass the radar was correct 91% of the time with its testing whereby only one sample was misclassified.

In summary, the experiments showed the effectiveness of the radar system to measure milk fat percentage. Radar raw data show distinguishable scattering patterns for the four milk products (Skim, 1%, 2%, and 3.25%), especially at RX3 and RX4. The machine learning component shows great potential for learning the extracted signatures and further predict the milk% of any tested product. While there was misclassification for 1 carton in each pass, however practically a re-work flag is raised only if back-to-back cartons are classified incorrectly. Therefore, the system will forgive the 1% milk classification in a 3.25% product line. However, if back-to-back cartons are classified as 1%, this will trigger a warning and the milk line will be stopped. The machine learning models herein used are simplistic to allow for quick classification in this POC given the small amount of measured data. Advanced models (e.g., deep neural networks) are more powerful (on larger datasets) and worth investigating to ensure real-time detection.

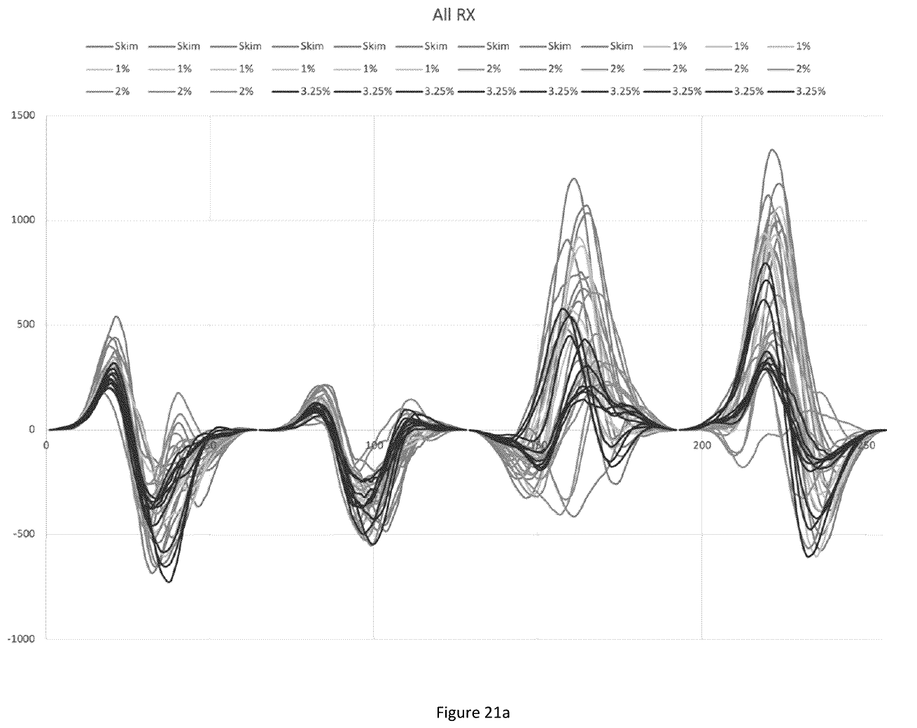

Turning to FIGS. 22a to 22c, different results from testing of other liquids is shown. FIG. 22a shows a measured parameter after passing mm-Wave radar through three types of Coke™; FIG. 22b shows a second parameter for the same measurements; and FIG. 22c shows a confusion matrix generated after processing the measurements through the system.

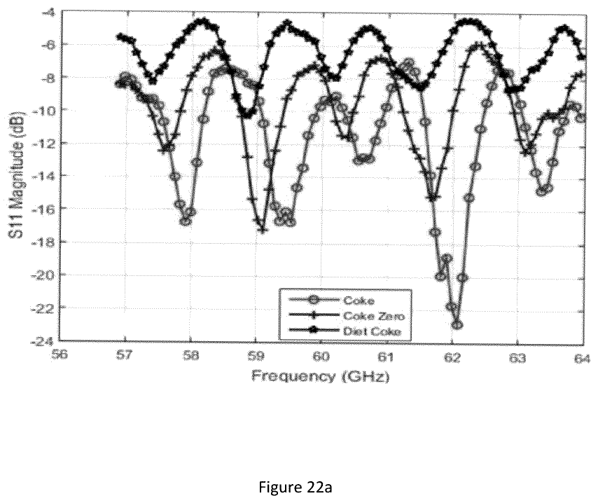

FIG. 23 illustrates another embodiment of a sensing system. The sensing system 1000 for sensing biometric and environmental characteristics. In particular, the system 1000 includes at least one transmitter 1010 and at least one receiver 1020. The transmitter 1010 is configured to transmit electromagnetic waves at a frequency generally between 30 GHz and 300 GHz or an appropriate subset of this frequency range depending on the required functionality. In some cases, the at least one transmitter 1010 may be a 2-channel transmitter configured to transmit between 30 to 67 GHz. The transmitter is intended to transmit electromagnetic waves at an object 1030 to determine a characteristic of interest. In some cases, the characteristic may be a biometric characteristic, for example, a fingerprint, a palm print, a respiration rate, a heart rate, a glucose level, a gait velocity, a stride length or the like. In other cases, the characteristic may be environmental, for example, presence of impurities, air quality, explosive detection, or the like. In yet another embodiment, the characteristics may be characteristics relating to a liquid such as a butterfat percentage of the milk, volume of content or amount of contaminants within the liquid. The characteristics may also relate to food packaging.

Once the electromagnetic waves that have interacted with the object 1030 are received at the receiver 1020, the data may be transmitted to a control station 1040. The control station 1040 may be, for example, a computer, a purpose-built device, or other device configured to receive and analyze the data. The control station 1040 includes at least one processor 1050 configured to carry out computer-readable instructions with respect to the data received. The data received may be reviewed and may have various processes or algorithms applied to it. In some cases, a decision tree may be generated to better analyze the characteristics of the object in question.

The system 1000 may also include a memory component 1060 used for example, for storing data, computer instructions, programs, machine learning and the like. The memory component 1060 may also or alternatively be an external database, cloud storage or the like. The system 1000 may also include a display 1070 and/or other user interface components in order to view and/or interact with results of the analysis. In other cases, for example in fingerprint detection, the result may simply be the unlocking or granted access for the individual and no display may be included in the system.

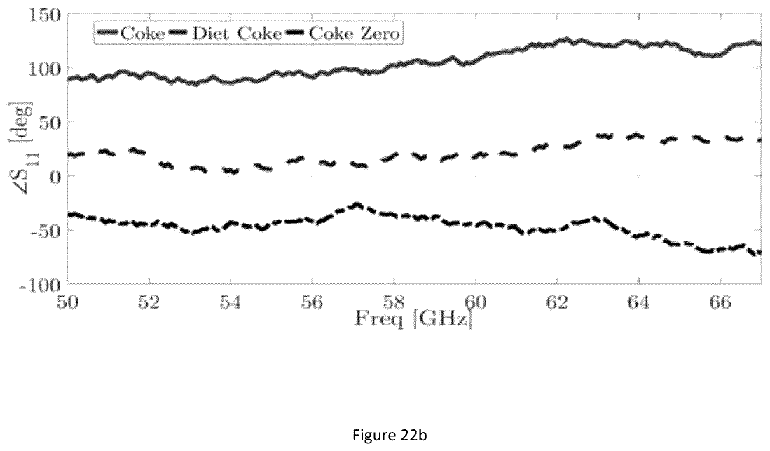

FIG. 24 provides further detail with respect to the system 1000. In some embodiments, a signal is provided to the transmitter 1010 (shown as a transmitting antenna) via an RF Generator 1080. In some cases, the signal is passed through a power divider 1090 to the transmitter 1010. The reflected signal is received at the receiver 1020 (shown as a receiving antenna) and provided to a pre-amplifier 1100. The signal is then combined with the signal from the transmitter (via the power divider 1090) to provide for a result, via for example a mixer 1110. The power divider 1090 may provide for signal adjustment prior to providing the signal to be combined. In some cases, the signal bay be reduced/attenuated by 3 dB, although other adjustments/reductions in amplitude may also be used.

Once the signal results are obtained, the signal results may be filtered by a filter 1120, for example a low pass filter. The signal may then be amplified by an amplifier 1130 and converted to a digital signal by an analog to digital converter 1140. Once a digital signal, it can be further processed by the control station 1040.

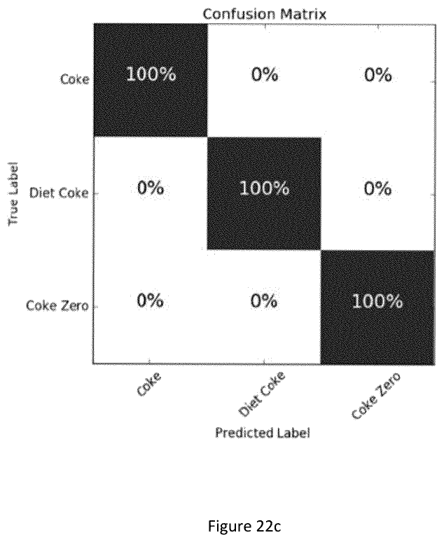

FIG. 25 illustrates a method 1200 for sensing characteristics of an object of interest. The sensing system 1000 may be populated or pre-populated with data related to the characteristic of interest, at 1210. For example, if the system 1000 is intended to sense fingerprints to allow authorization to certain individuals, results for the individuals may be pre-populated to the system 1000. Alternatively, the characteristic may relate to the composition of liquids and therefore, composition ranges may be pre-populated to the system. It will be understood that this may occur during a setup of the system 1000 or may re-occur when other data becomes relevant to the system 1000. The system 1000 is unlikely to be populated each time the method 1100 is run by the system.

At 1220, the transmitter transmits electromagnetic waves to an object to determine a characteristic of interest. It is intended that the electromagnetic waves are between 30 GHz and 300 GHz. At 1230, the waves are then received by the at least one receiver configured to receive the electromagnetic waves from the transmitter. The transmitter and receiver are positioned in relation to an object to be scanned such that the receiver receives electromagnetic waves (for example, reflected) in order to determine the characteristic of interest of the object.

At 1240, the results are analyzed. In some cases, the results may be analyzed using machine learning. In other cases, other analysis may be performed to determine whether the characteristic of interest is present in the object r the characteristic itself.

At 1250, the system 1000 makes a decision as to whether the characteristic of interest is present. For example, in detecting ammonia, the system 1000 may determine whether there is presence of ammonia to a predetermined threshold or if there is no ammonia detected.

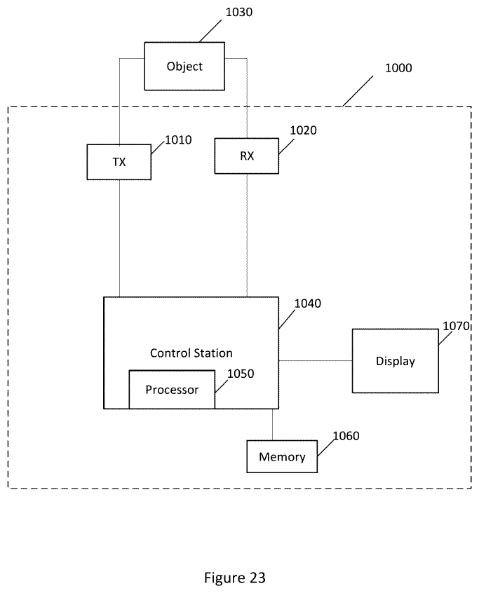

FIG. 26 illustrates various signal processing techniques/approaches that can be used by the system to analyze the data received. It will be understood that depending on the particular application, the history and the processing of the data, various differing results may be obtained.

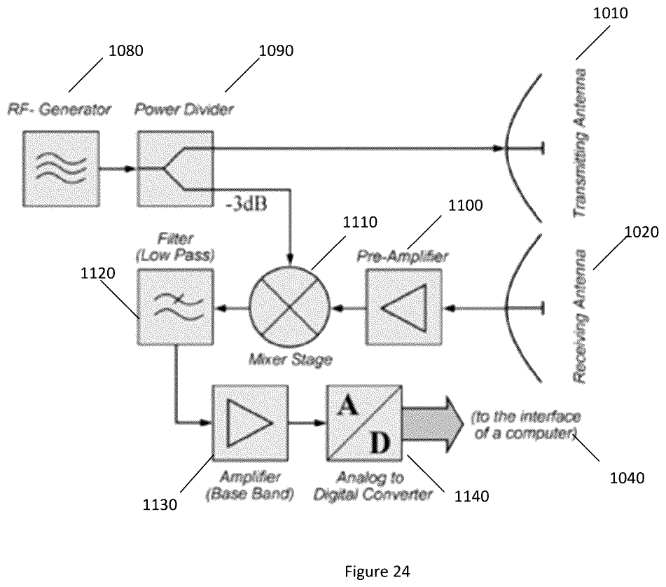

FIG. 27 illustrates a method 1300 for sensing biometrics, and in particular a palm print using an embodiment of the system detailed herein. At 1310, the signal is transmitted by a transmitter, the signal reflects off a hand, and at 1320 the signal is received by a receiver. At 1330, the signal is provided to the system for analog pre-processing. At 1340 the analog signal has been converted to a digital signal (see D/A converter above) and is digital pre-processed by the system. At 1350 signal transformations are completed by the system. At 1360, the system may perform feature extraction in relation to characteristics of interest with respect to the palm print. At 1370, the system provides recognition/non-recognition with respect to the characteristics of interest and is able to determine whether the palm print is, for example, an authorized palm print. At 1380, the system provides the results to the application, for example, opening a door, turning on a phone, opening secure software, or the like.

Embodiments of the system and method of the disclosure may also find benefit from use in monitoring blood glucose levels. In one embodiment, the blood glucose levels may be monitored with respect to diabetes non-ionizing electromagnetic radiations in order to reduce or eliminate hazards when penetrating the body. The sensors of the disclosure were coupled with frequency-compatible radar boards to realize small mobile glucose sensing systems of reduced cost.

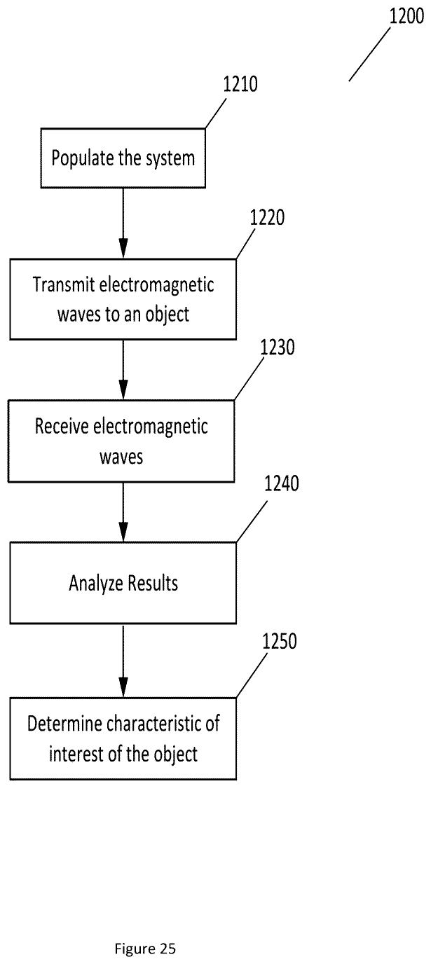

Turning to FIG. 28, a first embodiment of a wearable version of a glucose monitoring device is shown. The glucose monitoring device of FIG. 28 includes the CSRR sensor as discussed above. The device 2800 includes a flexible antenna 2802 and a TP-CSRR sensor 2804 that includes a transmitter and a receiver for transmitting and receiving electromagnetic waves. The device 2800 is connected (such as via cables 2808) to a glucose measuring unit 2806 that processes the reflected or received electromagnetic waves to determine the individual's glucose level. The results may then be transmitted to a mobile device 2810 so that the information can be displayed to a user and/or stored for future reference. The TP-CSRR biosensor in the tag/reader format enables non-invasive blood glucose monitoring.

The current embodiment provides a sensing distance between the communicating reader and tag that enables the device to be used as a wearable. The passive tag is based on the CSRR technology that offers multiple features when used for sensing. The sensing structure includes a groundless resonator that serves as a passive tag and a simple flexible antenna that works as a reader.

In one embodiment, the tag sensing includes three similar cells of circular CSRRs patterned horizontally on the top layer of an FR4 dielectric substrate (ϵᵣ′=4.4 and tan δ=0.02) as schematically shown in FIG. 28b. In this specific embodiment, the sensing elements (three CSRRs) in the passive tag are coupled to the remote interrogator antenna at the operating frequency f=2.3 GHz. The three CSRRs in the sensing tag are configured to realize a larger sensing region of concentrated electric field, thus enabling a higher sensitivity for glucose detection. The device of FIG. 28a provides a wearable on the finger of an individual for continuous blood glucose level monitoring. In other embodiments, the device may also be adapted as a wearable around a wrist of an individual.

The reader portion of the device coupled with the sensing tag could be of any antenna type that conforms to the wearable standards including, but not limited to, a low-profile, low-cost, simple-geometry, and directional electromagnetic radiation pattern to enhance the performance efficiency of the integrated sensor when attached to the finger part. When the tag is electrically coupled by the antenna radiation at the resonance frequency, an electric field of high localization and concentration will be generated along the tag surface in the near-field region, thus allowing the sensor to detect small variations in the electromagnetic properties that characterize the varying glucose levels in the underlying tissue. The attached finger would consequently perturb the distribution of the highly concentrated electric field in the tag, and further induce noticeable changes in the scattering response at the antenna port. The variations in the reflected signals are further analyzed to extract the signature of the measured blood glucose level.

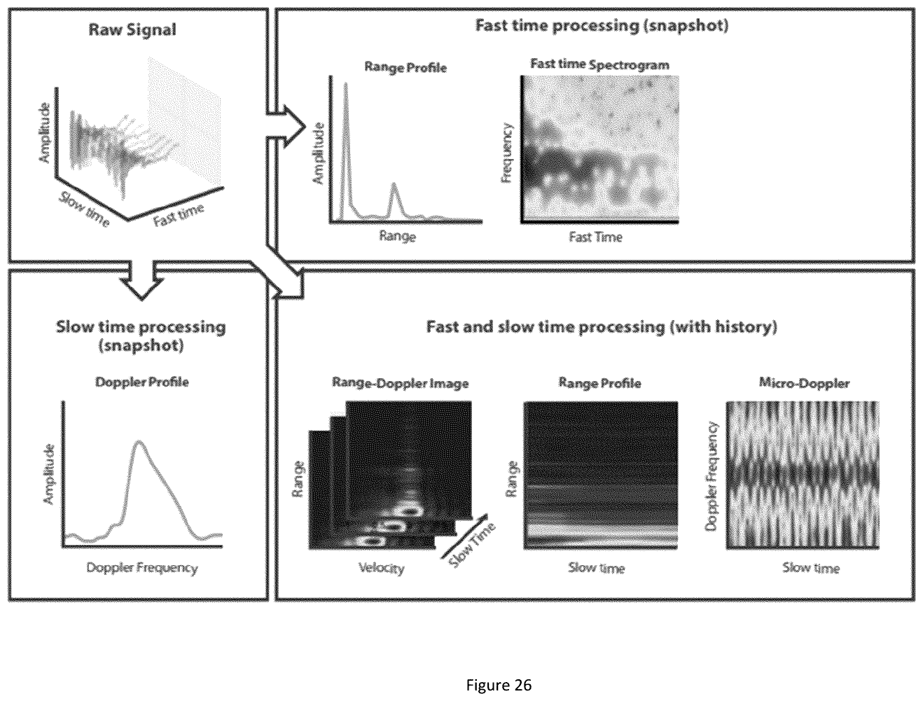

Experiments were performed on the device of FIG. 28a using a HFSS FEM simulator. First, a λ/2 dipole antenna was designed using a perfect electric conductor (PEC) to couple the passive TP-CSRR tag at the operating frequency f=2.3 GHz as shown in FIG. 29a. The passive resonators in the tag were electrically excited from distance d as shown in FIGS. 29b and 29c. Accordingly, the dipole antenna acted as an active reader that communicates from this sensing distance with the TP-CSRR tag when used for glucose sensing.

Before loading any glucose sample, the performance of the integrated sensor was compared to that of a bare dipole antenna (FIG. 29a) and when a single-pole CSRR is patterned in the tag (FIG. 29b). FIG. 29d depicts the simulated reflection coefficients S₁₁ (return loss) over the frequency range 1-4 GHz for the three respective cases. The bare antenna has a wideband reflection response that resonates around f=2.32 GHz with −7.23 dB return loss. The S₁₁ is shifted slightly towards lower frequencies when the passive tags are attached at distance d=4 mm from the dipole. In particular, the scattering response is shifted to f=2.27 GHz and f=2.22 GHz for the SP-CSRR and TP-CSRR tags, respectively. Additionally, attaching the passive tag would strengthen the resonance perceived at the antenna port and narrow its 3-dB bandwidth. It is also observed that the TP-CSRR tag exhibits a steeper resonance peak/depth of about −12.18 dB compared to −11.36 dB for the case of SP-CSRR. Having three cells integrated together on the tag surface will relatively enhance the resonance strength and confine the resonating electric fields over a larger sensing region via exploiting the mutual coupling originated between the three resonating cells.

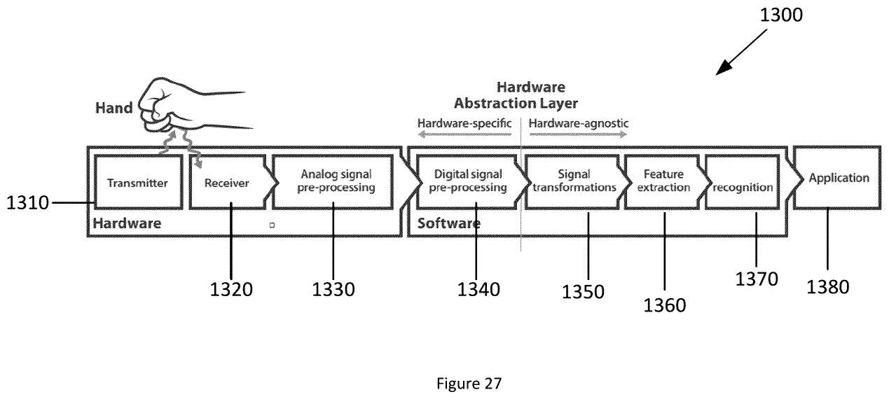

The sensor performance was analyzed when the glucose concentrations of interest, 60-500 mg/dl relevant to different diabetes conditions (normal, hypoglycemia, and hyperglycemia), were introduced in the sensing area on top of the tag as shown in FIG. 30a. The glucose samples were modelled in a rectangular shape of 39×13 mm² and 2 mm height inside a plexiglass container as shown in FIG. 30a. The sensing parameter used for tracking the glucose level variations was the reflection coefficient S₁₁ which represents the amplitude ratio of the reflected wave to the incident wave at the antenna port written with respect to frequency.

A first-order Debye model with the coefficients was used to approximate the dielectric properties of the blood mimicking samples at disparate glucose concentrations 60-500 mg/dL. The extracted model was integrated into the FEM simulator over the operating frequency range 1-4 GHz. The glucose samples were first simulated in proximity of the bare dipole antenna at d=4 mm without the TP-CSRR tag to study the effect of the glucose level variations on the electric field induced by the interrogating antenna and its scattering response. The parametric sweep function in HFSS was used to vary the εᵣ′ and tan δ parameters for the glucose samples G1-G8. As expected, no significant change in the antenna S₁₁ was observed in reaction to the varying dielectric parameters of the glucose samples in the vicinity of the radiator. It was determined that detecting the small changes in the electromagnetic properties of the glucose samples requires a highly confined and concentrated electric field that is not possible with a bare antenna setup wherein the radiated fields are dispersed around in the near- and far-field regions.

The full sensor structure with the TP-CSRR tag was analyzed for sensing the glucose concentrations inherent in the loaded samples G1-G8 as shown in FIG. 30a. The dipole antenna was placed at two sensing distances above the tag, 4 and 5 mm. The TP-CSRR has shown to be sensitive to the dielectric property changes of various glucose samples placed nearby the passive CSRR cells. This sensitivity to glucose dielectric contrast is translated to variations in the antenna reflection coefficient via the electromagnetic coupling between the dipole and the passive tag. As depicted in FIG. 30b, the electromagnetic field variations around the passive TP-CSRR when loaded with different glucose concentrations will affect the input impedance of the antenna, and hence its reflection coefficient.

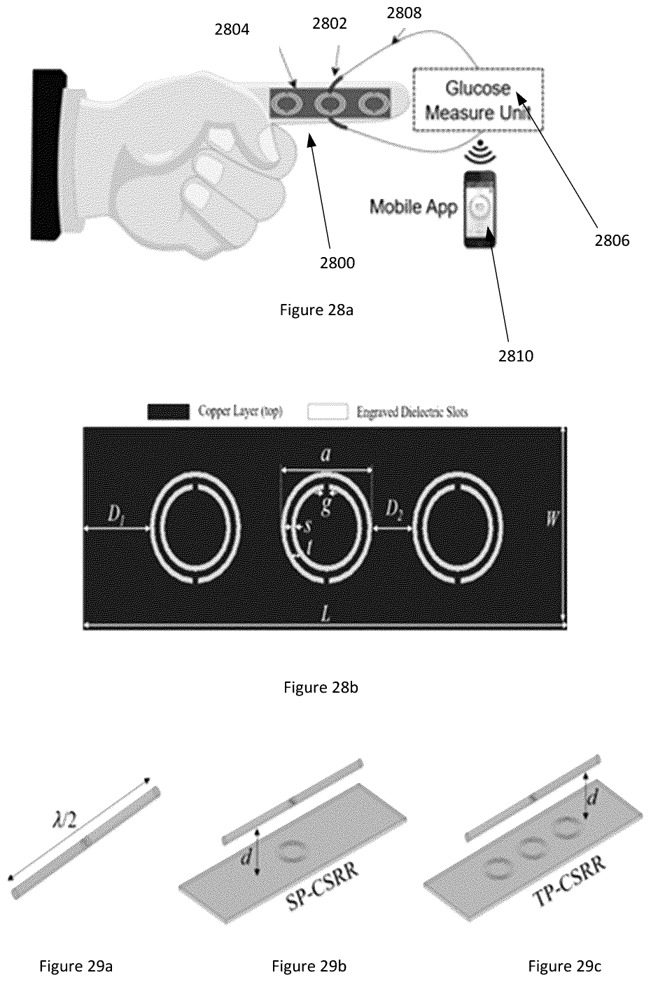

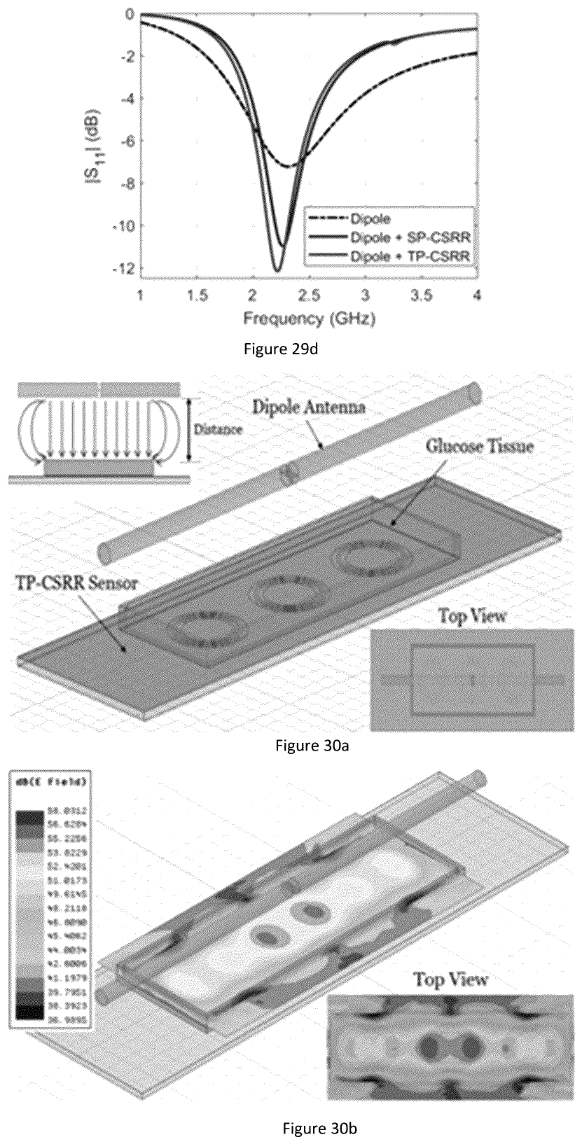

FIG. 31a shows the simulated reflection coefficient S₁₁ of the dipole in the frequency range 1-4 GHz when the TP-CSRR tag was placed at d=4 mm. Two resonances were observed around f=2 GHz and f=3.44 GHz. The resonant amplitude at both is varying in response to the glucose concentration changes G1-G8 as depicted in FIGS. 31b and 31c, respectively. However, the second resonance has shown more sensitivity with higher resolution to glucose level changes. Similarly, FIG. 32a shows the reflection responses for the case of d=5 mm with two resonances at f=2.04 GHz and f=3.32 GHz. Notably, the first resonance strength has significantly increased at this distance, and therefore brings a higher amplitude resolution for identifying different glucose concentrations.

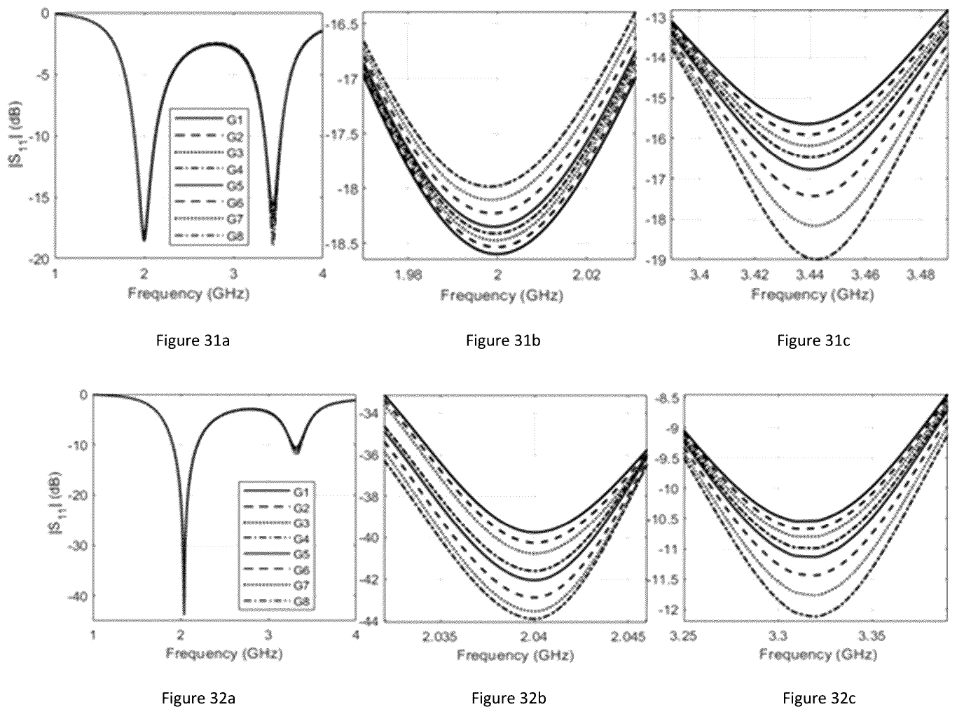

The glucose samples G1-G8 were also numerically simulated on top of a passive tag of a single CSRR cell at d=4 mm from the dipole to compare the glucose detection sensitivity to that of our proposed sensor that uses TP-CSRR tag. FIGS. 33a and 33b depict the resonant amplitude resolution at the varying glucose levels for both sensors. The minimum or low S₁₁ at the first resonance around f=2.06 GHz and f=2.0 GHz for different glucose samples introduced onto the SP-CSRR and TP-CSRR tag, respectively, are shown in FIG. 33a. FIG. 33b shows the same results at the second resonance around f=3.19 GHz and f=3.44 GHz, for the SP-CSRR and TP-CSRR, respectively. Clearly, the TP-CSRR tag realizes a larger amplitude resolution for tracking the glucose level changes. This is shown in FIGS. 33c and 33d which show that the electric field distribution across the G1 glucose sample at f=2.3 GHz when loaded onto each sensor. As shown in FIG. 33d, the electric field is highly concentrated in the TP-CSRR tag with higher magnitudes along a larger sensing region wherein the glucose samples are loaded. However, the electric field in FIG. 33c is relatively restricted in a smaller region that corresponds to one cell of the SP-CSRR tag.

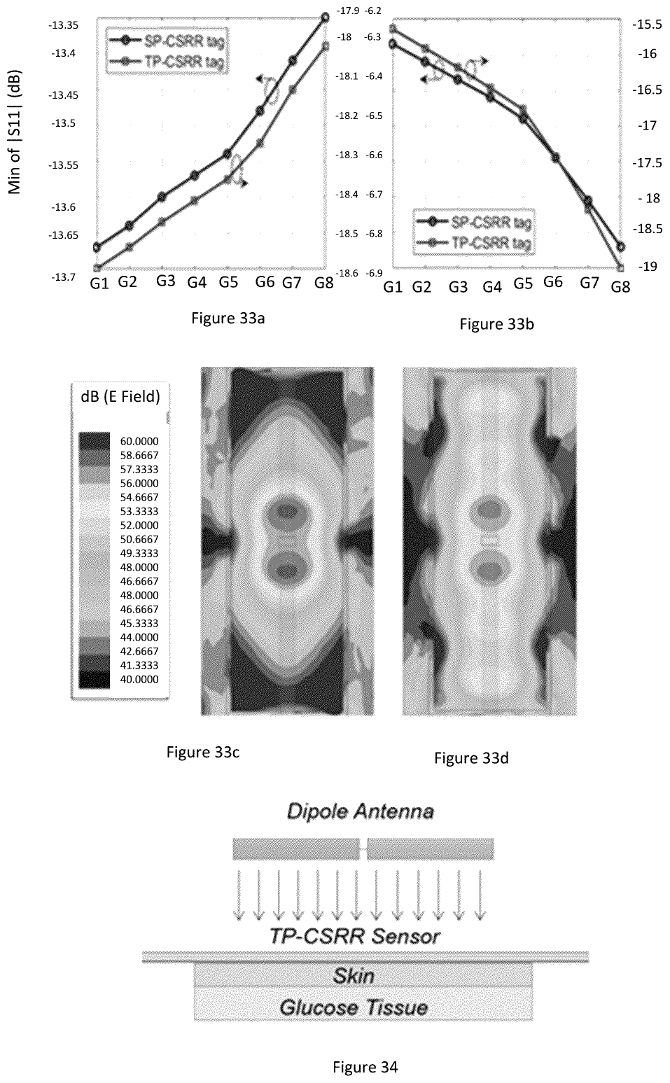

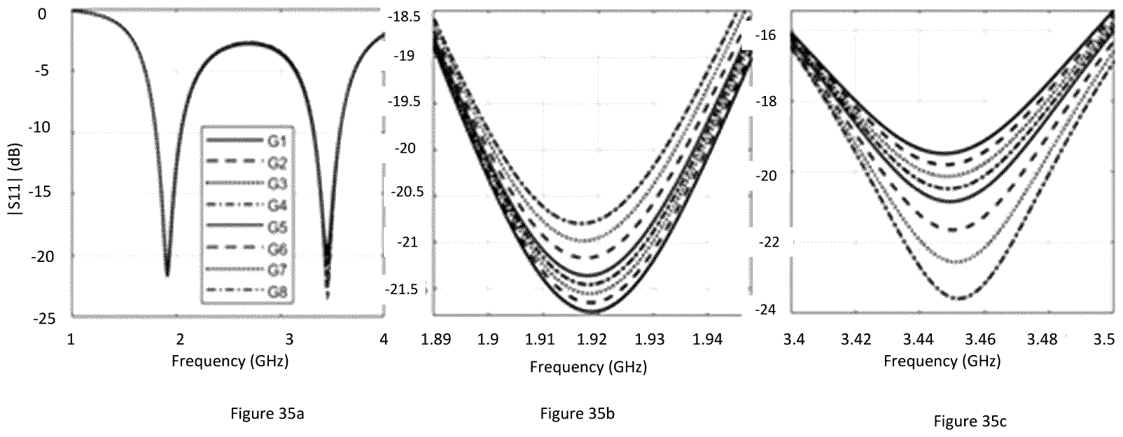

The sensitivity of the sensor was further studied when a skin layer (εᵣ′=38.1 and tan δ=0.28) of thickness 1 mm was introduced between the tag and the glucose samples G1 -G8 as shown in FIG. 34. This simulation model provided insights for the sensor performance in a practical scenario when the sensor is attached to the finger. The sensor response in the updated model was simulated over the frequency range 1-4 GHz as depicted in FIG. 35a, with two resonances induced at f=1.918 GHz (FIG. 35b) and f=3.45 GHz (FIG. 35c). Both resonances exhibit remarkable amplitude variations for the glucose level changes, however, the detection sensitivity is much higher (larger amplitude resolution) at the second resonance compared to that of the first resonance as shown in FIG. 35c and FIG. 35b, respectively. The sensor preserved the high sensitivity performance despite the inclusion of another lossy layer of the skin tissue.

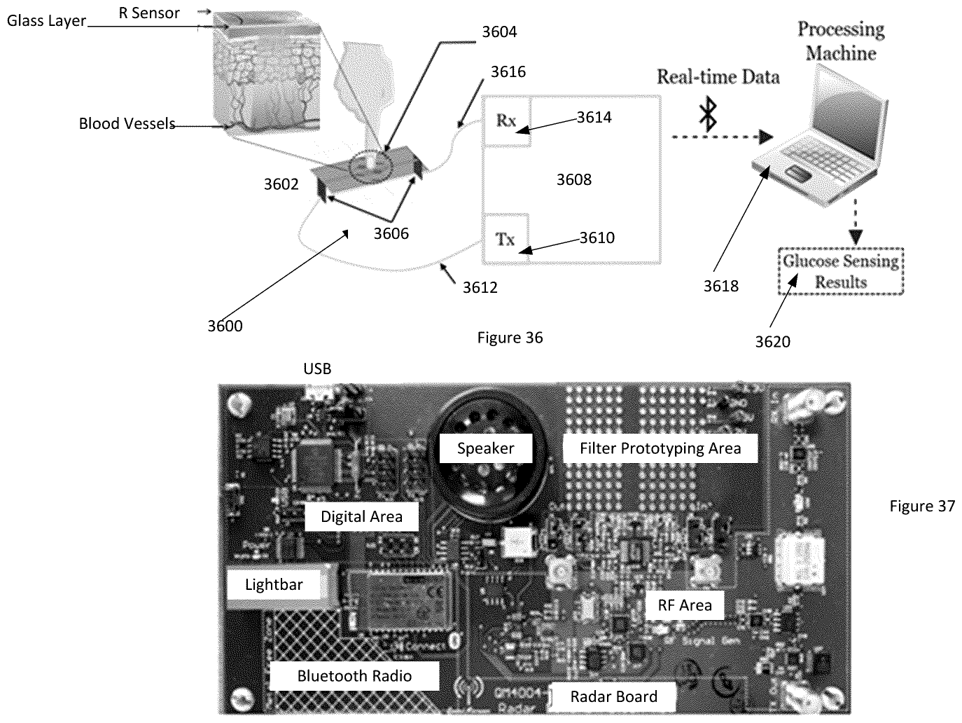

Turning to FIG. 36, another embodiment of a device for testing glucose using low frequency electromagnetic waves. The device 3600 includes a CSRR sensor 3602 which includes a sensing region 2604 for an individual to place a tip of their finger. A pair of smart metal alloy connectors 3606 are located at each end of the CSRR sensor 3602. The sensor 3602 is connected via the connectors 3606 to a radar printed circuit board (PCB) 3608 or an associated radar with one connector connected to a transmitter 3610 of the PCB 3608 via a transmitter coaxial cable 3612 and the other connector connected to a receiver 3614 of the PCB 3608 via a receiver coaxial cable 3616. The radar PCB 3608 is connected to a processing machine 3618 (such as a computer) to transmit the received signals (or real-time data) so that the processing machine 3618 can process the real-time data to determine glucose sensing results 3620.

In a specific embodiment of FIG. 36, the radar is a low-cost 2.45 GHz ISM band radar for measuring glucose level non-invasively in the blood tissue. The compact honey-cell CSRR sensor 3602 is interconnected to the small low-cost and -power radar module 3608 as a driving source. Open-source QM-RDKIT, which supports the frequency modulated continuous wave (FMCW) functionality, was utilized to couple the CSRR sensor at the ISM frequency range (2.4-2.5 GHz) via the coaxial cables.

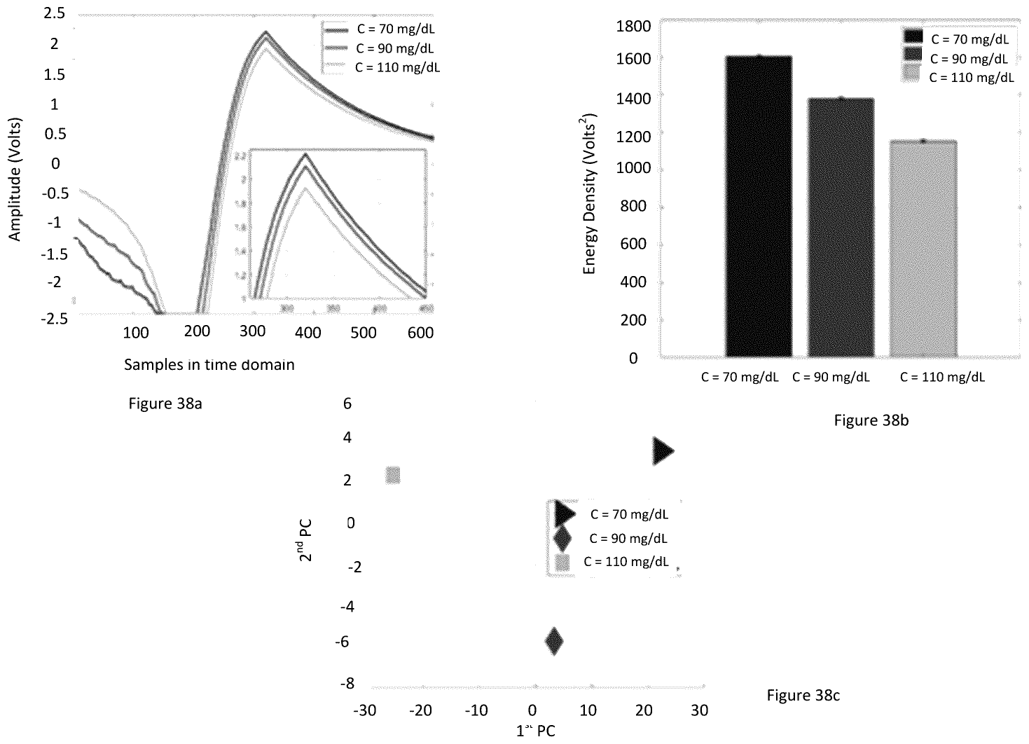

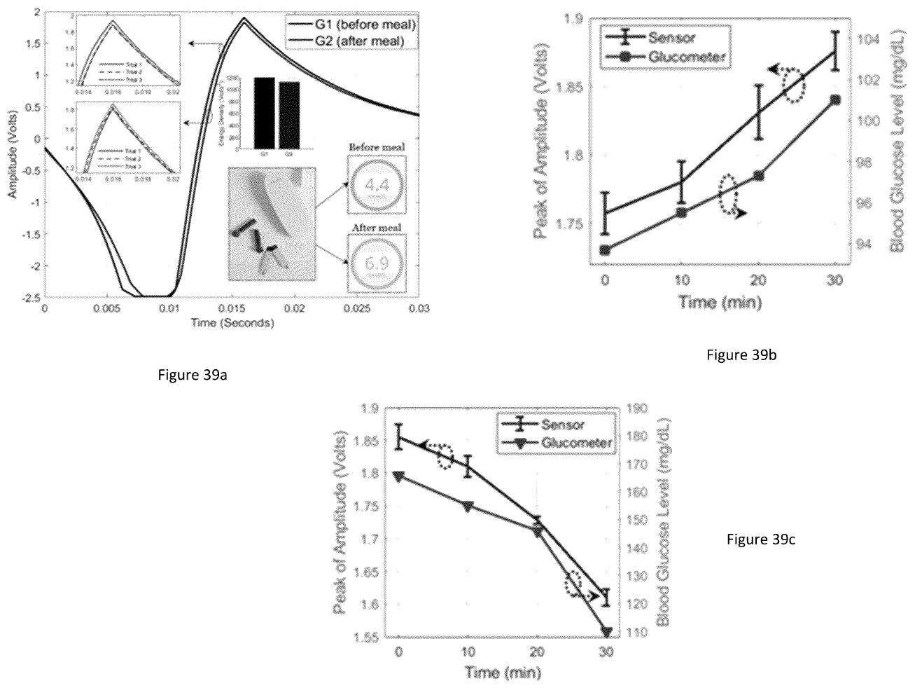

FIG. 37 provides a schematic diagram of the radar PCB. In this embodiment, the PCB 3608 includes a lightbar, a Bluetooth™ radio, a digital area, a USB port, a speaker, a filter prototyping area, and a radio frequency area. The radar PCB may include other components or sections as will be understood. The RF section or area generates and outputs the transmitted signal and down-converts the received signal to a frequency range that can be easily digitized using an onboard Analog-to-Digital converter (ADC). Specifically, the onboard Voltage Controlled Oscillator (VCO) and Phase Lock Loop (PLL) are used to generate the transmitted signal of defined frequency. The PLL serves to frequency lock the output of the VCO using the onboard reference to provide a stable and repeatable output frequency. The output of the VCO is amplified before being passed to the input port of the interconnected sensor. The corresponding signal from the sensor output port is first mixed with a sample of the transmitted signal to produce a frequency offset (beat frequency), then it is filtered to remove any unwanted signals developed from the mixing process. Afterwards, the signal is passed to the ADC for digitization, and either stored in memory or streamed over the USB/Bluetooth connection. In addition to the ADC, the digital section also contains the PIC microcontroller, USB, and power interfaces. The PIC microcontroller coordinates all functions of the radar board, responds to all control commands and data requests received through the USB/Bluetooth connections. FIGS. 38a to 38c show results from in-vitro experiments using the sensor of FIG. 36 where FIG. 38a is the raw data for tested glucose samples as collected on the receiving channel, FIG. 38b is a comparison of energy density and FIG. 38c are PCA processed results.

For in-vivo experiments using the sensor of FIG. 37, the sensor was tested for a simple in-vivo experiment as a proof-of-concept for this technology when revised for intermittent or continuous blood glucose level monitoring. For this purpose, the CSRR compact sensor was attached to a fixture structure suitable for finger placement. The structure was designed to enable users to precisely place their finger onto the sensor for accurate measurements. Another advantage of the sensor is that it is portable and has more advantages when compared to other current portable blood glucose level measuring instruments.

Tests were performed on a healthy male volunteer before and after having the lunch meal while comparing the non-invasive measurements against a standard glucometer used as a reference for comparison. This testing recipe was guided by the fact that, in healthy non-diabetic people, the blood glucose should measure between 72-99 mg/dl before a meal and should be less than 140 mg/dL two hours after a meal. Therefore, a pre-prandial test was first performed for the tested subject by placing his fingertip suitably in the sensing region inside the fixture.

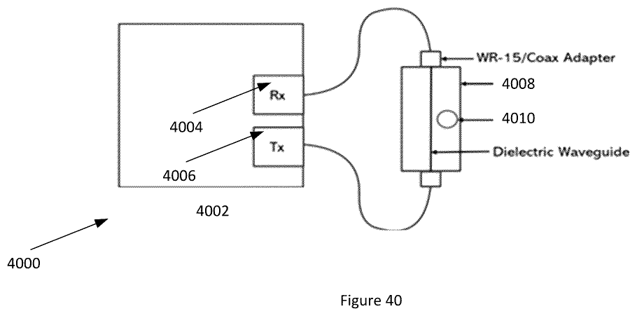

In use, the finger should be in contact with the sensing region (firmly attached to the fixture) to perturb the electromagnetic fields and induce noticeable changes in the sensor transmission response. The sensing process from the fingertip would take a short time of about one-minute during which no changes in the temperature status of the subject finger is expected. The corresponding raw data in response of a one-way single-sweep transmission was collected from the radar receiving channel using the featured graphical user interface. The same test was repeated three times for repeatability verification and the average of the three readings (with ±0.03 Volts error max) is plotted in FIG. 39a (black curve). Afterwards, the individual's blood glucose level was measured using the commercial invasive glucometer to get the actual pre-prandial blood glucose level of about 4.4 mmol/L (≈ 80 mg/dL). Similarly, a second test was performed for the tested subject two hours after having a lunch meal for normal diet. The test on the non-invasive sensor was repeated for three consecutive times and the average voltage signal is plotted in FIG. 39a (blue curve). The post-prandial blood glucose level was measured at 6.9 mmol/L (≈124 mg/dL) on the glucometer.

Following these measurements, the transmission results of the CSRR sensor were observed to be reliably consistent and aligned with the glucometer readings for the individual BGL variations before and after the meal. Particularly, the sensor transmitted signal exhibits a change in amplitude and a shift in time domain in response to the varying blood glucose level of the tested subject. The black curve corresponds to 80 mg/dl blood glucose level while the blue one represents the 124 mg/dl reading that leveled up two hours after the meal intake.

To better understand the blood glucose level detection, the measured sensor data was further analyzed and processed using the Discrete Fourier Transform (DFT) algorithm. The consequent energy density has shown to be varying for the two processed data corresponding to the two different blood glucose level readings, 80 and 124 mg/dL, as depicted in the enclosed plot in FIG. 39a, that shows an energy density of about 1207 and 1122 Volts², respectively. This would also imply that the sensitivity to glucose variation is slightly reduced when compared to that of the samples in glassy container. In fact, the coupled electric field in the sensing region has less interaction with the glucose molecules in this case given the lossy nature of the fingertip biological structure including the cornified skin layer. This is seen very clearly when a skin layer model was introduced in the numerical simulations showing the field intensity with decaying magnitudes halfway through the glucose-contained layer. However, the sensitivity could be enhanced by modifying the design specifications through incorporating a flexible substrate of smaller loss tangent or utilizing a more powerful driving circuit (>1 Watt output power) instead of the RDKIT used in this preliminary prototype as a proof-of-concept.

To confirm the correlation of the sensor readings to that of the actual blood glucose level in real-time setting, another experiment was performed while continuously monitor a volunteer's blood glucose level over a course of 30 minutes before and after a meal. First, the pre-prandial test was conducted, and the corresponding sensor data were collected every 10 minutes resulting into four distinct readings. At each trial instant, the measurement was repeated for three times while placing the fingertip and the average of was plotted in FIG. 39b in terms of peak amplitudes (blue curve). The invasive readings were collected accordingly using the Glucometer and plotted FIG. 39b (red curve). The sensor measurements follow the trend of the reference blood glucose level that increases slightly in the range 93.7-101 mg/dL. In this narrow range of blood glucose level variation, the sensor readings exhibited a repeatability error of about ±0.0198 Volts max.

The post-prandial test was performed similarly right after the meal (˜10 mins) by collecting four distinct readings over a period of 30 minutes. The average of three repeatable sensing trials was plotted in FIG. 39c in terms of the peak amplitudes with a repeatability error of about ±0.019 Volts. The invasive measurements revealed a significant jump to 165.7 mg/dl 10 mins after the meal intake, then dropped slightly to 155, 146, then 110 mg/dL by the fourth check performed 40 mins after the meal. The sensor readings follow this descending pattern as depicted in FIG. 39c. The sensor results for both pre- and post-prandial measurements shows no delay compared to the reference blood glucose level, thus indicating the direct blood glucose level monitoring from blood.

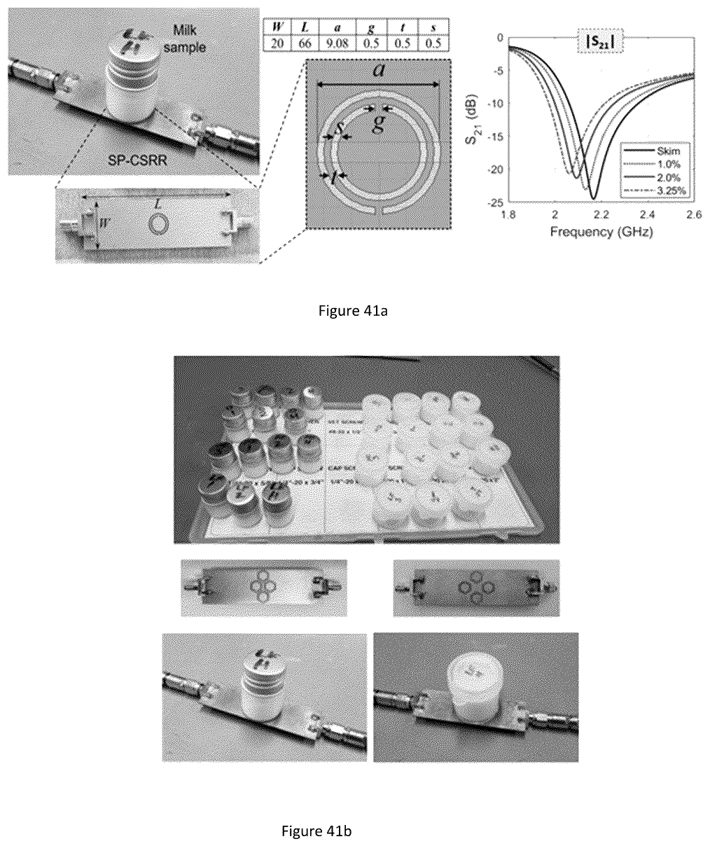

Turning to FIG. 40, a schematic diagram of another embodiment of a sensor for testing glucose levels is shown. The current embodiment may be seen as a portable high-band glucose sensor. The sensor 4000 includes a radar, seen as a radar PCB 4002 that includes a receiver component 4004 and a transmitter component 4006. The radar PCB 4002 is connected to a WGM sensor 4008 which includes a sensing region 4010 for testing the fingertip. The receiver component 4004 is connected to one end of the WGM sensor 4008 via a receiver cable and the transmitter component 4006 is connected to an opposite end of the WGM sensor 4008 via a transmitter cable.

Ina specific embodiment, the sensor 4008 is a mm-wave WGM sensor with the radar board 4002 operating in 60-64 GHz. In the current embodiment, a radar board that supports FMCW functionality in the mm-wave range was used to couple the WGM sensor at the input and output ports to the radar board.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

Embodiments of the disclosure or elements thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the embodiments can also be stored on the machine-readable medium. The instructions stored on the machine-readable medium can be executed by a processor or other suitable processing device and can interface with circuitry to perform the described tasks.

The above-described embodiments are intended to be examples only. Alterations, modifications and variations can be affected to the particular embodiments by those of skill in the art without departing from the scope, which is defined solely by the claims appended hereto.

What is claimed is:

1. A method for testing a packaged item comprising:
transmitting a set of low range electromagnetic waves at the packaged item;
receiving a set of scattered low range electromagnetic waves, wherein the set of scattered low range electromagnetic waves are fully correlated to the packaged item;
determining a relative complex permittivity of the packaged item; and
processing the relative complex permittivity to determine a characteristic of the packaged item.

2. The method of claim 1 wherein the packaged item is a packaged fluid.

3. The method of claim 2 wherein the packaged fluid is milk and the characteristic is one of a butterfat percentage of the milk, volume of content or amount of contaminants.

4. The method of claim 1 wherein transmitting a set of low range electromagnetic waves comprises transmitting electromagnetic waves in a frequency range of about 1 GHz to about 300 GHz.

5. The method of claim 3 further comprising, after receiving a set of scattered low range electromagnetic waves, determining a dielectric constant and a dielectric loss factor for the packaged fluid.

6. The method of claim 5 wherein determining a relative complex permittivity of the packaged fluid comprises processing the dielectric constant and the dielectric loss factor.

7. The method of claim 6 wherein processing the dielectric constant and the dielectric loss factor comprises processing a magnitude and phase of complex scattering data using a machine learning algorithm (MLA).

8. The method of claim 7 wherein the MLA comprises a time series random forest (RF), support vector machines (SVM), a principal component analysis (PCA), a recurrent neural network (RNN), a gated recurrent unit (GRU), long short-term memory models (LSTM), or a complex neural network.

9. The method of claim 1 wherein the set of scattered low range electromagnetic waves are a set of reflected low range electromagnetic waves.

10. The method of claim 1 further comprising, after receiving a set of scattered low range electromagnetic waves, processing the set of scattered low range electromagnetic waves via a continuous wavelet transform (CWT), an empirical mode decomposition (EMD), a discrete wavelet transform (DWT), a power spectral density (PSD), a fast Fourier transform (FFT), or short-time Fourier Transform (STFT).

11. A glucose monitoring device comprising:
at least one transmitter for transmitting electromagnetic waves at a target;
at least one receiver for receiving reflected electromagnetic waves from the target; and
a glucose monitoring unit for processing the reflected electromagnetic waves.

12. The glucose monitoring device of claim 11 wherein the at least one transmitter and the at least one receiver are implemented within a complementary split-ring resonators (CSRR) sensor.

13. The glucose monitoring device of claim 12 wherein the CSRR sensor is a single pole CSRR sensor, a triple pole CSRR sensor or a honey-cell CSRR sensor.

14. The glucose monitoring device of claim 11 wherein the at least one transmitter and the at least one receiver are implemented within a whispering-gallery mode (WGM) sensor.

15. The glucose monitoring device of claim 11 wherein the at least one transmitter and the at least one receiver are connected to the glucose monitoring unit via individual co-axial cables.
